(19) United States
(12) Patent Application Publication
(10) Pub. No.: US 2025/0312770 A1
(43) Pub. Date: Oct. 9, 2025

(54) ALKYL-SUBSTITUTED HYDROXAMATE RESIN FOR USE IN A GENERATOR SYSTEM

(71) Applicant: Brookhaven Science Associates, LLC, Upton, NY (US)

(72) Inventors: Vanessa A. Sanders, Sound Beach, NY (US); Leah Marie Gajecki, New York, NY (US); Melissa Ann Deri, New York, NY (US)

(21) Appl. No.: 18/863,020

(22) PCT Filed: May 16, 2023
(86) PCT No.: PCT/US2023/022355

§ 371 Date: Nov. 5, 2024

Related U.S. Application Data
(60) Provisional application No. 63/344,194, filed on May 20, 2022.

(51) Int. Cl. B01J 20/288; B01J 20/26

(52) U.S. Cl. CPC B01J 20/288; B01J 20/265; B01J 2220/52

(57) ABSTRACT

In one aspect, the disclosure relates to a hydroxamate-based resin for use in a ⁴⁴Ti/⁴⁴Sc generator system. In an aspect, the carboxylate groups of a commercially available resin can be synthetically modified to produce an alkyl-substituted hydroxamate resin. In one aspect, the carboxylate resin can be a commercial resin. The disclosure also relates to a ⁴⁴Ti/⁴⁴Sc generator system comprising an alkyl-substituted hydroxamate resin of Formula I and a method of producing ⁴⁴Sc, the method comprising decay of ⁴⁴Ti in a ⁴⁴Ti/⁴⁴Sc generator system using an alkyl-substituted hydroxamate resin of Formula I. In an aspect, the alkyl can be methyl. The disclosure further relates to a ¹⁷²Hf/¹⁷²Lu generator system comprising the use of an alkyl-substituted hydroxamate resin of Formula I and a method of producing ¹⁷²Lu comprising decay of ¹⁷²Hf in a ¹⁷²Hf/¹⁷²Lu generator system using an alkyl-substituted hydroxamate resin. In an aspect, the alkyl can be methyl.

### CROSS-REFERENCE TO RELATED APPLICATIONS

This application claims the benefit of U.S. Provisional Application No. 63/344,194, filed on May 20, 2022, which is incorporated herein by reference in its entirety.

### STATEMENT REGARDING FEDERALLY SPONSORED RESEARCH OR DEVELOPMENT

This invention was made with government support under contract number DE-SC0012704 awarded by the U.S. Department of Energy. The United States government has certain rights in the invention.

### BACKGROUND

Scandium 44 (⁴⁴Sc) is of high interest as a potential positron emission tomography (PET) imaging radionuclide due to its promising characteristics such as high positron branching ratio (94.27%) and 3.97 hour half-life, making it a suitable candidate for radiolabeling of small to medium biomolecules since it matches their biological half-lives. ⁴⁴Sc has even shown slightly superior image resolution in radiopharmaceutical imaging compared to the analogous ⁶⁸Ga systems. Presently, ⁴⁴Sc can be obtained in one of two ways; irradiation of ⁴⁴Ca targets with low energy protons or through decay of the parent isotope ⁴⁴Ti in a ⁴⁴Ti/⁴⁴Sc generator system. While the solid targetry approach on calcium produces high yields of ⁴⁴Sc, due to the short half-life of ⁴⁴Sc the direct production requires access to a cyclotron at or near the imaging facility. More importantly during the irradiation several other Sc isotopes are produced which then requires extensive post-irradiation processing and purification before the ⁴⁴Sc can be subsequently used for radiolabeling. Employing a generator system allows for an alternative approach to the production of ⁴⁴Sc. In these systems a long-lived parent radionuclide (⁴⁴Ti) is adsorbed onto a solid phase matrix to facilitate chromatographic separations. Once the parent nuclide decays to the short-lived radionuclide of interest it is removed from the solid support through a facile process in a pure form. The ⁴⁴Ti/⁴⁴Sc generator system would allow for daily elution of ⁴⁴Sc without the need for on-site irradiation, and the long half-life of parent isotope ⁴⁴Ti (60 years) would allow for a potentially long-lasting source of pure ⁴⁴Sc.

Development of an acceptable ⁴⁴Ti/⁴⁴Sc radionuclide generator needs to address several criteria such as efficient separation, low ⁴⁴Ti breakthrough, long term stability and useful Sc eluates that will be suitable for subsequent radiolabeling (low volume, low pH, high purity). Several current generators employ the use of a commercial AG 1-X8 anion exchange resin eluting with dilute oxalic acid/hydrochloric acid mixtures, but there are numerous drawbacks to this method, such as the extremely large volumes needed to elute sufficient ⁴⁴Sc activity, short generator lifetimes before ⁴⁴Ti breakthrough, and the presence of competing oxalates in solution that will hinder subsequent radiolabeling.

More recently the use of commercially available ZR resin has been suggested as a possible resin for the ⁴⁴Ti/⁴⁴Sc radionuclide generator system. The Triskem hydroxamate based ZR resin has been previously used to separate Zr from Y, and due to the chemical similarities between the Zr(IV)/Y(III) and Ti(IV)/Sc(III) pair, it also shows high selectivity for Ti and little selectivity for Sc over a range of acid concentrations. While the high retention of ⁴⁴Ti on the ZR resin indeed seems promising, there is little to no information in the literature on the ⁴⁴Sc elution activity or generator lifetime. One study conducted by Radchenko et al. suggests ⁴⁴Ti breakthrough after 40 bed volume elutions of a conventional direct elution generator. Using ZR resin generators, the elution volumes needed compared to the AG 1-X8 generators is drastically decreased, but the generator lifetime before ⁴⁴Ti breakthrough as well as ⁴⁴Sc activity elution and purity of eluted ⁴⁴Sc has been extremely inconsistent and unreliable. There is an organic impurity that is eluted along with the ⁴⁴Sc which inhibits subsequent radiolabeling with DOTA, HOPO or NOTA under standard conditions. Thus, to date, there are no commercially available resins that provide a robust generator system that tightly retains ⁴⁴Ti while supplying pure ⁴⁴Sc in a convenient form for radiolabeling without the use of tedious post-elution processing and purification.

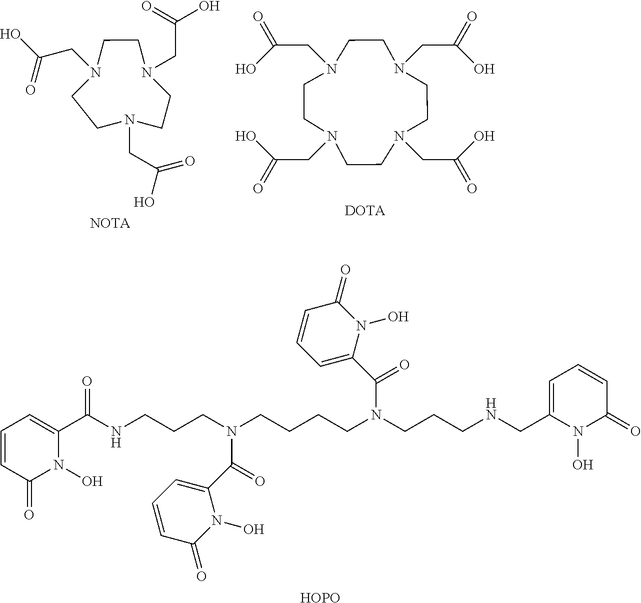

Despite advances in radionuclide generator research, there is still a scarcity of generators that retain ⁴⁴Ti while continuously supplying ⁴⁴Sc that is free of organic impurities that can hinder subsequent radiolabeling. Such a system would eliminate the need for post-elution processing and purification and could operate at reduced elution volumes compared to known methods. These needs and other needs are satisfied by the present disclosure.

### SUMMARY

The present disclosure is directed to a hydroxamate-based resin for use in a ⁴⁴Ti/⁴⁴Sc generator system. In an aspect, the carboxylate groups of a commercially available resin can be synthetically modified to produce an alkyl-substituted hydroxamate resin of Formula I (V$LG),

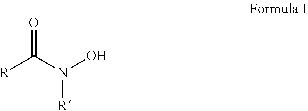

wherein R can be a resin backbone that is a polymer-coated silica based media and wherein R′ can be an alkyl group that can be branched or unbranched, is saturated, and has from about 1 to about 12 carbon atoms in its longest chain. In one aspect, the carboxylate resin can be an Accell Plus CM resin available from Waters™ (Milford, MA).

The disclosure also relates to a ⁴⁴Ti/⁴⁴Sc generator system comprising an alkyl-substituted hydroxamate resin of Formula I and a method of producing ⁴⁴Sc, the method comprising decay of ⁴⁴Ti in a ⁴⁴Ti/⁴⁴Sc generator system using an alkyl-substituted hydroxamate resin of Formula I. In an aspect, the alkyl can be methyl.

The disclosure further relates to a ¹⁷²Hf/¹⁷²Lu generator system comprising the use of an alkyl-substituted hydroxamate resin of Formula I and a method of producing ¹⁷²Lu comprising decay of ¹⁷²Hf in a ¹⁷²Hf/¹⁷²Lu generator system using an alkyl-substituted hydroxamate resin. In an aspect, the alkyl can be methyl.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows the amount of ⁴⁴Sc activity eluted in 0.5 M HCl fractions of exemplary generators based on detection of ⁴⁴Sc gamma peak at 1157 keV using HPGe γ spectroscopy. The ZR generator ⁴⁴Sc activity elution is shown in the darker bars and the methyl hydroxamate resin (AM) is shown in the lighter bars.

FIG. 2 shows an elution profile of a generator experiment where loading occurs in 2 M HCl and elution occurs with 0.5 M HCl.

FIG. 3 shows an elution profile of a generator experiment where loading occurs in 0.1 M HCl and elution occurs with 0.5 M HCl.

FIG. 4 shows an elution profile of a generator experiment where loading occurs in 2 M HCl and elution occurs with 2 M HCl, where ZR and AU are as described previously and V$LG is equivalent to an AM resin.

FIG. 5 shows an elution profile of a 1 mCi AM generator experiment as described herein.

FIG. 6 shows an elution profile of a 720 μCi AM generator experiment as described herein.

FIG. 7 shows an elution profile of a 1 mCi AM generator experiment as described herein.

FIG. 8 shows a stripping profile of 1 mCi ⁴⁴Ti generator using 2% H₂O₂ in 2 M HCl. Each fraction represents 8 bed volumes (8 mL).

FIG. 9 shows a decay scheme of ¹⁷²Hf by EC to ¹⁷²Lu (t_{1/2}=6.7 days) which then decays by electron capture to stable ¹⁷²Yb.

FIG. 10 shows preliminary cold studies were conducted using the methyl hydroxamate resin to ascertain the distribution coefficient (K_{D}) for both Hf and Lu in varying concentrations of HCl to determine the extent of this generator system. As shown in the plot, Hf is retained strongly on the resin across all concentration of the acid, similarly to Ti. Lu, on the other hand, shows little to no retention across the HCl concentrations. Based on the similarities in the K_{D} results of the Ti/Sc and Hf/Lu studies we believe that this resin would also serve as a suitable generator for Hf/Lu.

FIG. 11 shows Ti and Sc distribution coefficient dependencies on HCl concentration for AM resin.

FIG. 12 shows an elution profile for a 2 M HCl 37 MBq (1 mCi) AM generator.

FIG. 13 shows an elution profile for a 0.5 M HCl 37 MBq (1 mCi) AM generator shown as activity obtained in the first 1 mL fraction and the second 1 mL fraction.

FIG. 14 shows total organic content analysis of 0.5 M HCl eluent from ZR and AM resin columns.

FIG. 15 shows total organic content analysis of 2 M HCl eluent from ZR and AM resin columns.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

In one aspect, in the methods disclosed herein, the carboxylate groups of commercially available Waters™ Accell Plus CM resin and other commercially available resins can be synthetically altered to produce alkyl-substituted hydroxamate functional groups, such as, for example, methyl-substituted hydroxamate functional groups. In an alternative aspect, a commercially available hydroxamate resin can be used in the methods disclosed herein. In a further aspect, the silica-based media of the Accell resin allows for a chemically robust resin backbone, and, without wishing to be bound by theory, the alkyl substituent on the hydroxamate functional group lowers the pKₐ of the modified resin, compared to the protonated/unsubstituted form which can allow for stronger metal binding.

In an aspect, R′ represents the alkyl substituent on the hydroxamate functional group. In a further aspect, alkyl groups can branched or unbranched, can be saturated, and can have from 1-12 carbon atoms in their longest chains, or can have 1, 2, 3, 4, 5, 6, 7, 8, 9, 10, 11, or 12 carbon atoms. Further in this aspect, non-limiting examples of suitable straight-chained, saturated alkyl groups include methyl, ethyl, n-propyl, n-butyl, n-pentyl, n-hexyl groups and dodecyl. In a preferred embodiment, the straight chain, saturated alkyl group can be a methyl group.

In another aspect, non-limiting examples of suitable branched, saturated alkyl groups include isopropyl, isobutyl, sec-butyl, t-butyl, 1-methylbutyl, 2-methylbutyl, 3-methylbutyl (isopentyl), 1,1-dimethylpropyl, 1,2-dimethylpropyl, 2,2-dimethylpropyl (neopentyl), 1-methylpentyl, 2-methylpentyl, 3-methylpentyl, 4-methylpentyl groups, and 2-methyl-5-ethyldecyl. In a preferred embodiment, the branched, saturated alkyl groups include isopropyl and/or t-butyl.

In one aspect, the disclosed alkyl-substituted hydroxamate resin can be synthesized in two steps using commercially available reagents under mild conditions (Scheme 1). Further in this aspect, R is a resin backbone that can be a polymer-coated silica based media. In a still further aspect, RCOOH can be preferably a Waters™ Accell Plus CM resin. In one aspect, R′ is an alkyl group that can be branched or unbranched, can be saturated, and can have from 1-12 carbon atoms in its longest chain.

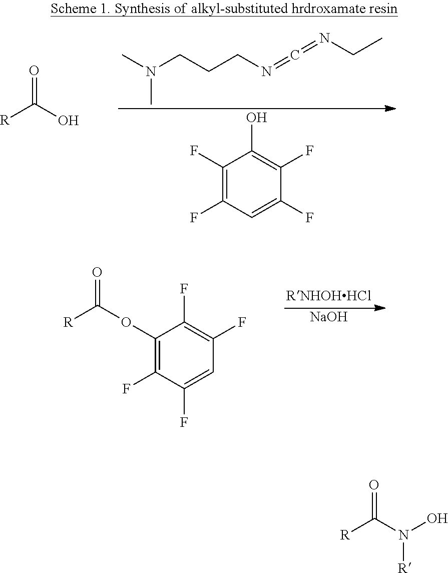

In a preferred embodiment, R′ is methyl. In one aspect, a methyl-substituted hydroxamate resin can have Formula II, shown below:

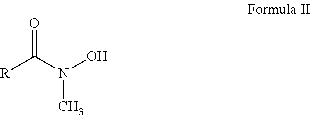

In one aspect, a methyl-substituted hydroxamate resin is synthesized as follows. In an aspect, Accell Plus CM resin (1.0 g) is suspended in water (8.0 mL) in a Falcon tube and a solution of 2,3,5,6-tetrafluorophenol (TFP) in acetonitrile (1.0 mL, 1.2 M) and 1-ethyl-3-(3-dimethylaminopropyl) carbodiimide hydrochloride (EDAC) (0.385 g) are added. In a further aspect, this is allowed to mix by inversion at room temperature for 1 hour after which an additional molar equivalent of TFP solution (1.0 mL, 1.2 M) and EDAC (0.385 g) are added to the Falcon tube. In one aspect, the solution is then mixed by inversion at room temperature for 2 hours. In a further aspect, the resin can then be isolated by vacuum filtration, washed with water and acetonitrile, and dried by continuous suction. In another aspect, the ester resin can then be converted to the N-methyl-substituted hydroxamate resin by reacting with N-methylhydroxylamine hydrochloride (0.837 g) in a methanolic 1 M NaOH solution at room temperature for 18 hours and mixing by inversion. In a still further aspect, the final resin can be isolated by vacuum filtration, washed with water and acetonitrile, and dried by continuous suction. In any of these aspects, the resins can be characterized using ATR-IR spectroscopy.

In any of these aspects, the resin can preferentially bind a parent isotope over a daughter isotope. In an aspect, the resin can have a distribution coefficient of greater than or equal to 5000 for the parent isotope and a distribution coefficient of less than or equal to 5 for the daughter isotope. In one aspect, the parent isotope can be ⁴⁴Ti and the daughter isotope can be ⁴⁴Sc. In an alternative aspect, the parent isotope can be ¹⁷²Hf and the daughter isotope can be ¹⁷²Lu.

Also disclosed are radionuclide generator systems having an elution bed, wherein the elution bed contains an alkyl-substituted hydroxamate resin as disclosed herein. In a further aspect, the radionuclide generator systems preferentially retain a parent isotope in contact with the alkyl-substituted hydroxamate resin while allowing a daughter isotope to be eluted. In some aspects, the elution bed can have a bed volume of from about 0.3 mL to about 2 mL, or of about 0.3, 0.4, 0.5, 0.6, 0.7, 0.8, 0.9, 1, 1.1, 1.2, 1.3, 1.4, 1.5, 1.6, 1.7, 1.8, 1.9, or about 2 mL, or a combination of any of the foregoing values, or a range encompassing any of the foregoing values. In another aspect, the radionuclide generator system can be loaded with from about 20 μCi to about 10 mCi of the parent isotope, or about 20, 50, 75, 100, 150, 200, 250, 300, 350, 400, 450, 500, 550, 600, 650, 700, 850, 900, or 950 μCi, or about 1, 2, 3, 4, 5, 6, 7, 8, 9, or 10 mCi of the parent isotope, or a combination of any of the foregoing values, or a range encompassing any of the foregoing values. In an aspect, the parent isotope can decay while in contact with the alkyl-substituted hydroxamate resin, releasing the daughter isotope.

Also disclosed herein is a method for producing ⁴⁴Sc, the method including contacting ⁴⁴Ti with the disclosed alkyl-substituted hydroxamate resin, allowing at least a portion of the ⁴⁴Ti to decay to ⁴⁴Sc, and eluting the ⁴⁴Sc. In an aspect, the ⁴⁴Sc can be eluted with a dilute aqueous solution. In one aspect, the dilute solution can be an acid such as, for example, HCl, or can be saline, or any combination thereof. In another aspect, the HCl can have a concentration of from about 0.01 M to about 10.8 M, or from about 0.5 M to about 8 M, or of about 0.01, 0.05, 0.1, 0.25, 0.5, 1, 1.5, 2, 2.5, 3, 3.5, 4, 4.5, 5, 5.5, 6, 6.5, 7, 7.5, 8, 8.5, 9, 9.5, 10, or about 10.8 M, or a combination of any of the foregoing values, or a range encompassing any of the foregoing values. In one aspect, the ⁴⁴Sc can be eluted with at least one bed volume of the acid, or can be eluted with two, three, four, or more bed volumes of the acid. In still another aspect, the elution step can be repeated at least once before the resin releases any ⁴⁴Ti. In some aspects, depending on bed volume, ⁴⁴Ti purity, and other factors, step (c) can be conducted at least 75 times before the resin releases any ⁴⁴Ti.

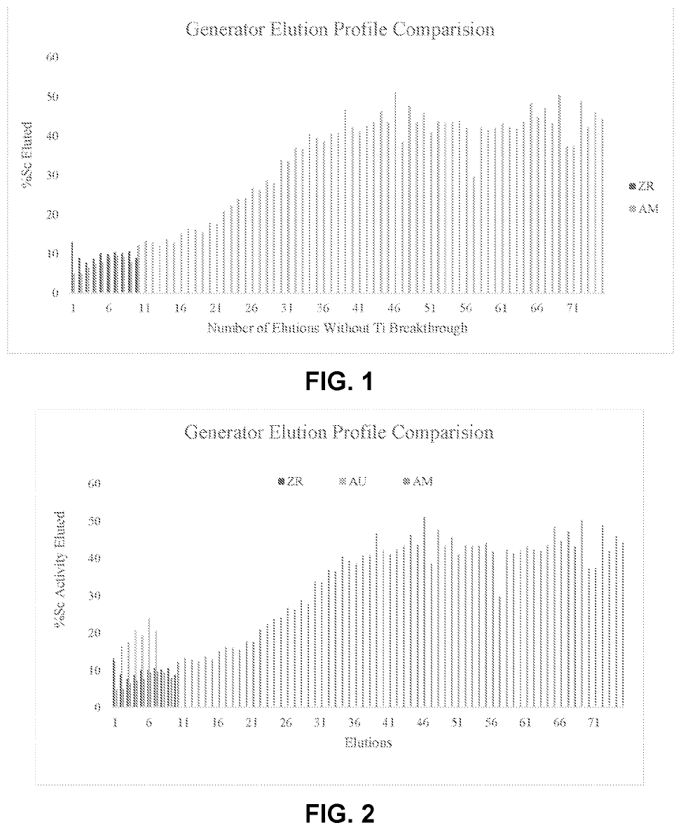

In one aspect, the methyl-substituted hydroxamate resin can be tested in comparison to the commercially available ZR resin in side-by-side generator evaluations. In a further aspect, the robustness of the generator can be investigated by monitoring: the time it takes until ⁴⁴Ti breakthrough, and the yield of ⁴⁴Sc. Further in this aspect, generators were loaded with a 20 μCi ⁴⁴Ti sample onto a 300 μL bed volume column in 2 M HCl and eluted daily with four bed volumes of 0.5 M HCl. In one aspect, each eluted fraction was monitored for ⁴⁴Ti breakthrough and the total amount of eluted ⁴⁴Sc activity was calculated using high purity germanium (HPGe) γ spectroscopy. In another aspect, once ⁴⁴Ti breakthrough was observed the generator was discarded, the elution profile for the ⁴⁴Sc comparison is shown below (FIG. 1). In a still further aspect, during the 11th elution the ZR generator displayed ⁴⁴Ti breakthrough, as observed through the detection of the 67.9 and 78.3 keV gamma peaks with an instrumentation error of <10%. The disclosed methyl hydroxamate resin (AM) generator was eluted for a total of 75 elutions before any ⁴⁴Ti breakthrough was observed.

In an aspect, the lifetime of the generator using the methyl hydroxamate resin is almost seven times longer than the ZR resin generator, and overall showed increased ⁴⁴Sc activity elution under the same conditions. In a further aspect, initial optimization studies also show drastically increased ⁴⁴Sc activity elution by varying the concentration of the HCl eluent. In one aspect, on a 300 μL bed volume generator using the disclosed AM resin loaded with 100 μCi ⁴⁴Ti, only 9% ⁴⁴Sc was eluted in 4 bed volumes of 0.5 M HCl, but 86% ⁴⁴Sc was eluted in the same volume using 2 M HCl with no observable ⁴⁴Ti breakthrough.

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a radionuclide,” “a resin,” or “an eluent,” includes, but is not limited to, mixtures or combinations of two or more such radionuclides, resins, or eluents, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of a resin refers to an amount that is sufficient to achieve the desired improvement in the property modulated by the formulation component, e.g. achieving the desired level of separation of ⁴⁴Ti from ⁴⁴Sc over the desired time period. The specific level in terms of wt % in a resin required as an effective amount will depend upon a variety of factors including the amount of resin, chemical identity of the resin including any substituents, initial ⁴⁴Ti to ⁴⁴Sc ratio, and eluent identity and concentration.

As used herein, the terms “optional” or “optionally” means that the subsequently described event or circumstance can or cannot occur, and that the description includes instances where said event or circumstance occurs and instances where it does not.

“Cold” as used herein refers to a reaction or molecule that is not radioactive. In an aspect, reactions and processes can be optimized using cold reagents and materials prior to performing the same reactions and processing with radioactive reagents and/or materials.

Unless otherwise specified, temperatures referred to herein are based on atmospheric pressure (i.e. one atmosphere).

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: Materials and Methods

### Chemicals and Reagents

All chemicals were used without further purification. Hydroxylamine hydrochloride, N-methylhydroxylamine hydrochloride, N-phenylhydroxylamine, 2,3,5,6-tetrafluorophenol (TFP), 1-ethyl-3-(3-dimethylaminopropyl) carbodiimide hydrochloride (EDC), potassium hydroxide, SOCl₂, anhydrous diethylether, acetonitrile (ACN), and HPLC grade methanol (MeOH) were purchased from Sigma Aldrich. Optima grade hydrochloric acid (HCl) was purchased from Fisher Scientific (Pittsburgh, PA, USA) and diluted to suitable concentrations (6 M, 4 M, 2 M, 0.5 M, 0.1 M) with 18 MΩ water (25° C., Milli-Q, Millipore, Burlington, MA, USA). ZR resin was purchased from Triskem Intl. (Brunz, France), Amberlite IRC50 resin and Amberlite CG50 resin were purchased from Sigma Aldrich and Accell Plus CM resin was purchased from Waters (Milford, MA, USA). Deionized Milli-Q water (18 MΩ, Millipore) which had been purified by passing through a 10 cm column of Chelex 100 resin (Bio-Rad Laboratories, Hercules, CA, USA) was used in all reactions and solution preparations.

### Measurement of Radioactivity

The absolute radioactivity of ⁴⁴Sc and ⁴⁴Ti was measured by γ-spectrometry using a high-purity germanium (HPGe) detector, samples were counted for 10 minutes. ⁴⁴Ti was detected directly via the 67.87 keV (93.0%) and 78.32 keV (96.4%) γ-lines and ⁴⁴Sc was detected via the 1157.02 keV (99.9%) γ-line.

### Synthesis of Resins

Accell Resins: Ester Resin. Accell Plus CM resin (1.0 g) was suspended in Chelex water (8.0 mL) in a 15 mL Falcon tube. TFP solution (1.0 mL, 1.2 M in ACN, 1.20 mmol) and EDAC (0.385 g, 2.48 mmol) were added to the Falcon tube. The reaction was mixed by inversion at room temperature for 1 hour, after which an additional 1.0 mL of TFP solution (1.2 M in ACN, 1.20 mmol) and EDAC (0.385 g, 2.48 mmol) were added to the reaction to ensure complete conversion of the carboxylate groups to the ester resin. The reaction was mixed by inversion at room temperature for a further 2 hours after which the final resin was isolated by vacuum filtration and washed with 3×15 mL water and 3×15 mL ACN and dried by continuous suction. This resin can be stored dry under ambient conditions without any apparent degradation or hydrolysis. IR (ATR, selected bands, vₘₐₓ): 3384, 1781, 1670, 1065, 956, 794, 452 cm⁻¹.

Accell Resins: UH Resin (AU). Hydroxylamine hydrochloride (0.695 g, 10.0 mmol) was dissolved in 1 M NaOH (1.0 mL) and MeOH (2.0 mL) to form the free base hydroxylamine. The ester functionalized resin (1.00 g) was added to this solution in a 15 mL Falcon tube and was mixed by inversion at room temperature for 18 hours. The hydroxamate resin was then isolated by vacuum filtration and washed with 3×15 mL water and 3×15 mL ACN. This resin can be stored dry under ambient conditions without any apparent degradation or hydrolysis. IR (ATR, selected bands, vₘₐₓ): 3347, 1731, 1660, 1451, 1062, 795, 451 cm⁻¹. Formation of the hydroxamate functional group was also verified by the visual formation of a dark red complex upon addition of Fe(III) in dilute acid to the resin.

Accell Resins: MH Resin (AM). The N-methylhydroxamate Accell resin can be synthesized by substituting N-methylhydroxylamine hydrochloride (0.837 g, 10.0 mmol) for the hydroxylamine hydrochloride in the above procedure. IR (ATR, selected bands, vₘₐₓ): 3361, 1733, 1654, 1449, 1062, 795, 452 cm⁻¹. Formation of the hydroxamate functional group was also verified by the visual formation of a dark red complex upon addition of Fe(III) in dilute acid to the resin.

Accell Resins: PH Resin (AP). N-phenylhydroxylamine (1.09 g, 10.0 mmol) was dissolved in MeOH (3.00 mL) and the ester functionalized resin (1.00 g) was added to this solution in a 15 mL Falcon tube. The reaction was mixed by inversion at room temperature for 18 hours and isolated and washed in accordance with the above procedure. IR (ATR, selected bands, vₘₐₓ): 3355, 1724, 1662, 1451, 1061, 795, 452 cm⁻¹. Formation of the hydroxamate functional group was also verified by the visual formation of a dark red complex upon addition of Fe(III) in dilute acid to the resin.

IRC50 Resins: Anhydride Resin. IRC50 resin (2.00 g) was suspended in SOCl₂ (6.00 mL) in a 25 mL round bottom flask fitted with a condenser, and the solution was refluxed for 4 hours. The resin was isolated by vacuum filtration and washed excessively with anhydrous diethyl ether to remove all unreacted SOCl₂ and dried by continuous suction. IR (ATR, selected bands, vₘₐₓ): 1800, 1745, 1456, 1390, 1258, 1111, 1007, 960, 853, 738, 713 cm⁻¹.

IRC50 Resins: UH Resin. Hydroxylamine hydrochloride (0.500 g, 7.20 mmol) was dissolved in MeOH (5.0 mL) and added to a solution of KOH (0.404 g, 7.20 mmol) in MeOH (5.0 mL). The KCl salt precipitated from solution immediately, but the solution was stored in the fridge for an hour to ensure complete precipitation of the salt. The salt was removed by filtration and the MeOH solution added to the anhydride resin (1.00 g) in a 15 mL Falcon tube. The reaction was mixed by inversion at room temperature for 1 hour, after which 3 M KOH (2.4 mL in MeOH, 7.20 mmol) was added to the Falcon tube. The reaction was mixed by inversion at room temperature for 5 minutes after which the resin was isolated by vacuum filtration and washed with MeOH. The potassium salt resin is then suspended in 0.1 M HCl (5.0 mL) and mixed by inversion at room temperature for a few minutes to protonate. The final resin was isolated by vacuum filtration and washed with water and MeOH and dried by continuous suction. This resin undergoes slow hydrolysis under ambient conditions over several days. IR (ATR, selected bands, vₘₐₓ): 3300, 1724, 1670, 1547, 1477, 1447, 1387, 1346, 1200, 1015, 969 cm⁻¹. Formation of the hydroxamate functional group was also verified by the visual formation of a dark red complex upon addition of Fe(III) in dilute acid to the resin.

IRC50 Resins: MH Resin. The N-methylhydroxamate IRC50 resin can be synthesized by substituting N-methylhydroxylamine hydrochloride (0.601 g, 7.20 mmol) for the hydroxylamine hydrochloride in the above procedure. This resin undergoes slow hydrolysis under ambient conditions over several days. IR (ATR, selected bands, vₘₐₓ): 3366, 1719, 1642, 1548, 1473, 1445, 1408, 1384, 1350, 1238, 1167, 1131, 1017, 966 cm⁻¹. Formation of the hydroxamate functional group was also verified by the visual formation of a dark red complex upon addition of Fe(III) in dilute acid to the resin.

IRC50 Resins: PH Resin. N-phenylhydroxylamine (0.786 g, 7.20 mmol) was dissolved in MeOH (6.0 mL) and added to the anhydride resin (1.00 g) in a 15 mL Falcon tube. The reaction was mixed by inversion at room temperature for 1 hour after which 3 M KOH (2.4 mL in MeOH, 7.20 mmol) was added to the reaction and mixed by inversion for 5 minutes at room temperature. The phenylhydroxamate resin was then isolated and washed in accordance with the above procedure. This resin undergoes slow hydrolysis under ambient conditions over several days. IR (ATR, selected bands, vₘₐₓ): 3361, 1692, 1652, 1540, 1473, 1446, 1403, 1343, 1256, 1181, 1019 cm⁻¹. Formation of the hydroxamate functional group was also verified by the visual formation of a dark red complex upon addition of Fe(III) in dilute acid to the resin.

CG50 Resins: Anhydride Resin. CG50 resin (2.00 g) was suspended in SOCl₂ (6.00 mL) in a 25 mL round bottom flask fitted with a condenser, and the solution was refluxed for 4 hours. The IR of the resulting resin showed incomplete conversion, so the resin was refluxed for a further 4 hr in fresh SOCl₂ (6.0 mL). The resin was isolated by vacuum filtration and washed excessively with anhydrous diethyl ether to remove all unreacted SOCl₂ and dried by continuous suction. IR (ATR, selected bands, vₘₐₓ): 1800, 1754, 1455, 1389, 1255, 1112, 1007, 960. 845, 737, 603 cm⁻¹.

CG50 Resins: UH Resin. The unsubstituted hydroxamate CG50 resin can be synthesized by substituting the CG50 anhydride resin (1.00 g) for the IRC50 anhydride resin in the above IRC50 UH resin procedure. IR (ATR, selected bands, vₘₐₓ): 3294, 1722, 1674, 1547, 1475, 1445, 1386, 1342, 1250, 1191, 1007, 965 cm⁻¹. Formation of the hydroxamate functional group was also verified by the visual formation of a dark red complex upon addition of Fe(III) in dilute acid to the resin.

CG50 Resins: MH Resin. The N-methylhydroxamate CG50 resin can be synthesized by substituting the CG50 anhydride resin (1.00 g) for the IRC50 anhydride resin in the above IRC50 MH resin procedure. IR (ATR, selected bands, vₘₐₓ): 3382, 1720, 1649, 1548, 1472, 1444, 1406, 1386, 1344, 1245, 1166, 1130, 1019, 966 cm⁻¹. Formation of the hydroxamate functional group was also verified by the visual formation of a dark red complex upon addition of Fe(III) in dilute acid to the resin.

CG50 Resins: PH Resin. The N-phenylhydroxamate CG50 resin can be synthesized by substituting the CG50 anhydride resin (1.00 g) for the IRC50 anhydride resin in the above IRC50 PH resin procedure. IR (ATR, selected bands, vₘₐₓ): 3366, 1698, 1647, 1485, 1446, 1387, 1340, 1253, 1172, 1018, 965 cm⁻¹. Formation of the hydroxamate functional group was also verified by the visual formation of a dark red complex upon addition of Fe(III) in dilute acid to the resin.

### IR Measurement

Attenuated total reflectance infrared (ATR-IR) spectroscopy was performed by using a Thermo Scientific Nicolet iS50 FTIR Spectrometer. The ATR-IR data were collected on dry solid samples and processed by using OMNIC version 9.3.32 software.

Preparation and Evaluation of ⁴⁴Ti/⁴⁴Sc Generators

Production of ⁴⁴Ti used in the radionuclide generators was conducted by irradiation of a scandium sputtering target (American Elements) at the Brookhaven Linac Isotope Producer (BLIP).

10 mL tapered Bio-Rad® columns were rinsed with Chelex water and filled to the bed volume (BV) with the corresponding resin that had been weighed and slurried in Chelex water. A small piece of glass wool was added to the top of the resin for protection, and the column washed with Chelex water and 2 M HCl or 0.1 M HCl. A sample of ⁴⁴Ti was evaporated to dryness and taken up in either 2 M HCl or 0.1 M HCl and loaded onto the columns by pipette. The solutions were allowed to elute by gravity. The generators were eluted 3 to 5 times per week with 4 BV of dilute HCl and collected and counted by fraction.

### Total Organic Content (TOC) Studies

10 mL tapered Bio-Rad® columns were rinsed with Chelex purified water and filled to a bed volume (BV) of 300 μL with the corresponding resin that had been weighed and slurried in Chelex purified water. Two columns were prepared with the ZR resin and two were prepared with the synthesized AM resin. One of each type of resin column was rinsed with 50 BV of 0.5 M HCl and the other two remaining columns with each type of resin was eluted with 50 BV of 2 M HCl. Samples were collected after 10, 20, 30, 40, and 50 BV of eluent and sent for total organic content (TOC) analysis at Long Island Analytical Laboratories Inc. (Holbrook, New York 11741). A blank of each acid used (0.5 and 2 M HCl) was also sent for analysis for comparison.

### Radiolabeling Experiments

Dry Down Method. In order to obtain the ⁴⁴Sc in a form suitable for radiolabeling, dry down processing was implemented where the generator eluted ⁴⁴Sc was evaporated dry on a hot plate in an open beaker at 140° C. and re-dissolved in 0.25 M NH₄OAc pH 4 buffer. Radiolabeling of generator eluted ⁴⁴Sc with DOTA, HOPO and NOTA was performed by mixing the ligand stock solution (0.04 mg/mL, 0.25 M NH₄OAc pH 4 buffer) with the post-processed ⁴⁴Sc (i.e., dried and re-dissolved ⁴⁴Sc) in a 1.5 mL Eppendorf tube and heating the solution at 90° C. for one hour in a thermomixer. The only parameter varied was the ligand concentration, which was pre-determined as a ligand molar excess over the ⁴⁴Sc molar amount (calculated by activity). The activity of ⁴⁴Sc used in radiolabeling varied from 25-50 μCi for the AM generator experiments, and 5-10 μCi for the ZR generator experiments due to varying generator and post-processing behavior.

Direct Radiolabeling Method. The ⁴⁴Sc generator eluent (in 0.5 M HCl) was obtained and neutralized with dilute NaOH solution and then used directly (e.g., without dry down processing) in subsequent labeling reactions. Radiolabeling of generator eluted ⁴⁴Sc with DOTA was performed by mixing the ligand stock solution (0.04 mg/mL, 0.25 M NH₄OAc pH 4 buffer) with the neutralized ⁴⁴Sc eluent in a 1.5 mL Eppendorf tube and heating the solution at 90° C. for one hour in a thermomixer. The only parameter varied was the ligand concentration, which was pre-determined as a ligand molar excess over the ⁴⁴Sc molar amount (calculated by activity). The activity of ⁴⁴Sc used in radiolabeling varied from 25-50 μCi.

For both methods, the dry down method and the direct radiolabeling method the radiolabeling yield was determined using thin-layer chromatography (iTLC-SG strips, Agilent). The plates were developed in 0.04 M NH₄OAc/MeOH (50/50) pH 5 buffer and were counted for 1 minute on a BIOSCAN AR 2000. The R_{f} values for the free ⁴⁴Sc and labeled ⁴⁴Sc (with all three ligands) were 0 and 0.9 respectively.

### Example 2: Results and Discussion

### Resin Synthesis and Characterization

The unsubstituted hydroxamate Accell resin (AU) was prepared following modified literature procedures by functionalizing the carboxylate groups of the Accell resin first to an ester, followed by conversion to the hydroxamate by reaction with hydroxylamine hydrochloride. The N-methylhydroxamate Accell resin (AM) can be synthesized using the same procedure substituting hydroxylamine hydrochloride for N-methylhydroxylamine hydrochloride. The N-phenylhydroxamate Accell resin (AP) can be synthesized from the ester functionalized resin using a similar procedure, but without the use of NaOH, as the N-phenylhydroxylamine is already in the free base form (Scheme 2). Addition of 1.0 mL of NaOH to the N-phenylhydroxylamine resin reaction results in hydrolysis of the ester resin back to the carboxylate form.

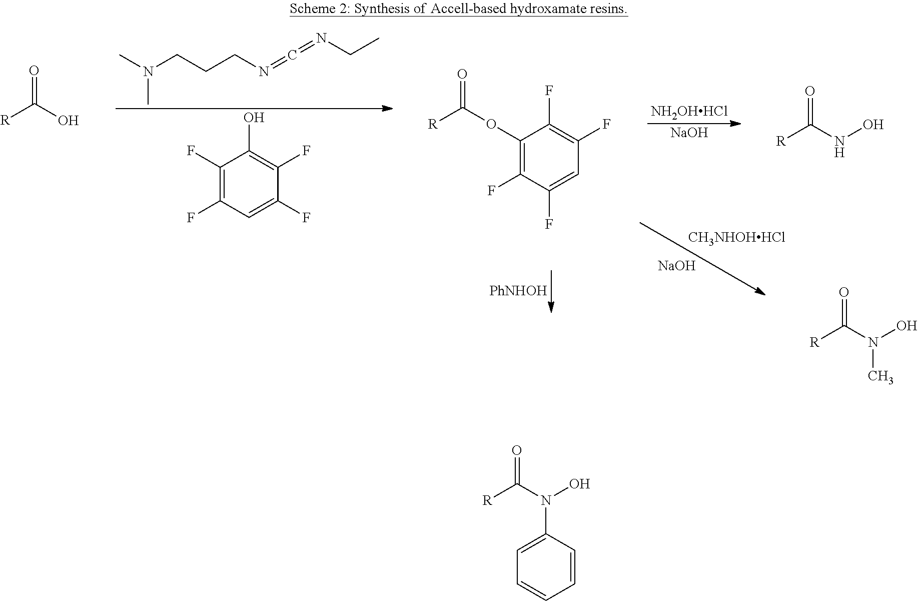

The characterization of the Accell resins by ATR-IR was difficult due to weak signal intensities caused by low ligand density and the overpowering silica peaks of the resin backbone. Because of this only the carbonyl region of the IR spectra was used in characterization. The starting Accell carboxylate resin shows asymmetric (vₐₛ) and symmetric (vₛ) C═O stretching frequencies at 1562 cm⁻¹ and 1408 cm⁻¹ respectively. In the intermediate ester resin this C═O stretching frequency shifts to higher energy at 1781 cm⁻¹. All three hydroxamate resins show a diagnostic C═O stretching frequency signal around 1730 cm⁻¹ as well as a second peak at around 1450 cm⁻¹, there is also evidence for the vₐₛ and vₛ carboxylate C═O peaks at approximately 1550 cm⁻¹ and 1400 cm⁻¹ respectively. There is no evidence of the carboxylate peaks in the ester resin, suggesting that there is some hydrolysis of the ester in the hydroxylamine reaction. The peaks seen at approximately 3400, 1650, 1065, 960, 800 and 450 cm⁻¹ in all of the Accell resin spectra are assigned as silica peaks, this was confirmed by direct comparison with the IR spectrum of crude silica gel. Formation of the hydroxamate functional group was also verified by the visual formation of a dark red complex upon addition of Fe(III) in dilute acid to the resin.

The procedure for the synthesis of the IRC50 and CG50 hydroxamate resins are the same but differ from the Accell resin synthesis. Attempts to use the same procedure as described above using IRC50 or CG50 resin did not result in formation of the ester functionalized resin in the first step, but rather formation of an anhydride. This was determined by characterization of the intermediate product using ATR-IR, which showed two C═O stretching frequencies at 1800 cm⁻¹ and 1750 cm⁻¹, this was true for both the IRC50 and CG50 resins. An alternate route to hydroxamate synthesis is conversion of carboxylates into acid chlorides which are then reacted with hydroxylamine, this has been suggested to work in the literature for similar resins. Reaction of IRC50 and CG50 with SOCl₂ under reflux resulted in the same anhydride product that was observed in the ester formation attempt (Scheme 3), this was evident by the identical IR spectrum of the product. Due to the high ligand density of the resins and the close contact of the neighboring carboxylate groups, all attempts at formation of the acid chlorides or esters (as in the Accell resin synthesis) always resulted in formation of the anhydride derivative without any apparent formation of the ester or acid chloride in any appreciable amounts.

There is literature evidence that it is possible to convert anhydrides into a 1:1 mix of hydroxamates and carboxylic acids by reaction with the free-based hydroxylamine and base. Based on this the hydroxamate IRC50 and CG50 resins were synthesized using modified literature procedures using the anhydride resin (Scheme 3). The hydroxylamine hydrochloride and N-methylhydroxylamine hydrochloride were free-based by reaction with one equivalent of KOH in MeOH, followed by removal of the KCl salt. This MeOH hydroxylamine solution was then added to the dry anhydride resin and allowed to react for 1 hour at room temperature. An additional molar equivalent of KOH in MeOH was then added briefly to catalyze the reaction to completion, but it was found that prolonged exposure of the hydroxamate resin to base resulted in hydrolysis back to the starting carboxylate resin. This product is presumably the potassium salt of the resin, so to protonate the hydroxamate groups the resin was washed in 0.1 M HCl. Exposure of this resin to ≥1 M HCl solutions resulted in hydrolysis of the hydroxamates back to carboxylates. Since the N-phenylhydroxylamine is already in the free base form this can be dissolved in MeOH and reacted directly with the anhydride resin, although addition of the catalytic KOH after the initial 1-hour reaction seemed to aid in the product formation.

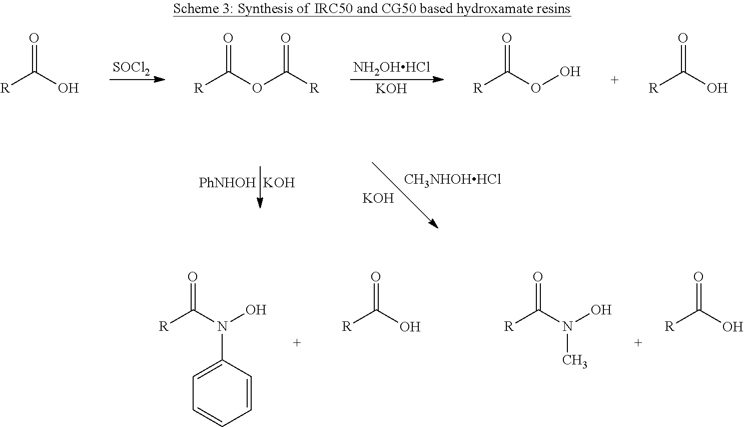

All six of these resins form dark red complexes in dilute acid solution with Fe(III) suggesting successful formation of the hydroxamate group. The IR spectra of resins show peaks due to both the carboxylate groups as well as the hydroxamate groups, with the C═O stretching frequency of the hydroxamate found around 1720 cm⁻¹ in all six resins. With the unsubstituted hydroxamate IRC50 and CG50 resins there was also sometimes an IR peak around 1680 cm⁻¹ (and no peak at 1720 cm⁻¹) that was not seen in the N-methyl or N-phenyl derivatives. This is likely due to the C═N stretching frequency that is present in the resonance form of the unsubstituted hydroxamate (Scheme 4).

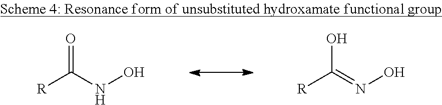

### K_{D} Studies of AM Resin

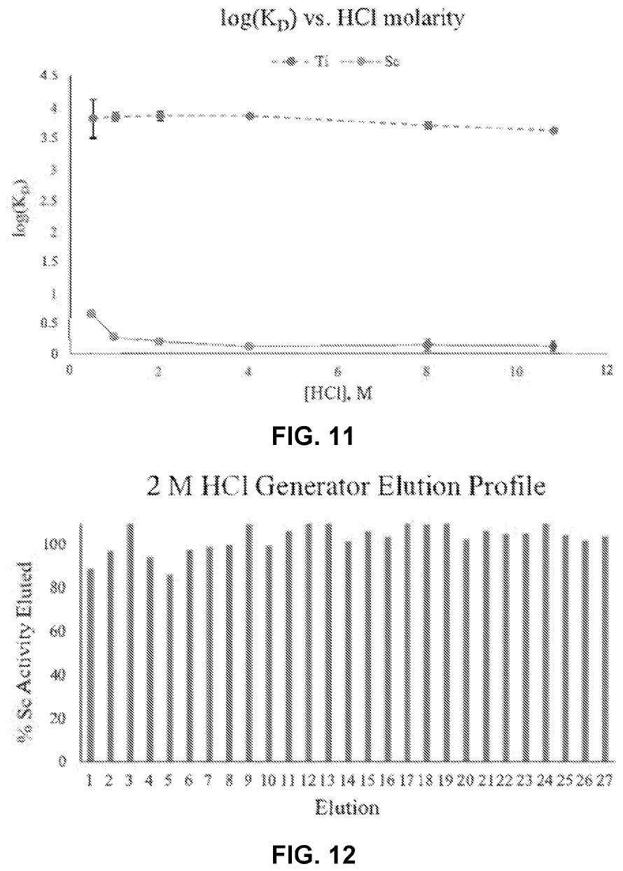

Results of the distribution coefficient studies of Sc and Ti on the AM resin in varying concentration of HCl are shown in FIG. 11. As can be seen clearly in the plot, Ti is strongly retained on the resin across all HCl concentrations with K_{D} values above 7000 across acid concentrations from 0.5 to 8 M, and a slight decrease to 5000 for the higher concentrations (8 and 10.8 M). Sc alternatively shows little to no retention across all HCl concentrations, all K_{D} values for Sc are below 2, except for 0.5 M HCl which is slightly increased to a K_{D} value around 4. These values are an improvement for both retention of Ti and weak affinity of Sc compared to the hydroxamate based ZR resin across a similar range of HCl concentrations. The slight increase of K_{D} values for Sc at low acid concentrations (0.5 M HCl) suggests that further dilute solutions of HCl (<0.5 M) may not be suitable to obtain appreciable amount of Sc from the resin in small volumes, but the large separation factor between Ti and Sc across all HCl concentrations tested here is extremely promising that this resin will be a good candidate for a ⁴⁴Ti/⁴⁴Sc radionuclide generator.

### Generator Performance

Study 1: Load in 2 M HCl, Elute in 0.5 M HCl. All generators had 300 μL BV and were loaded on the same day with 20 μCi of ⁴⁴Ti as well as three 300 UL BV “blank” generators loaded with 13 μCi of ⁴⁴Ti using the same procedure with unmodified IRC50, CG50 and Accell resins to ensure the carboxylate groups of the parent resin were not contributing to any metal binding. All nine synthesized resins were tested as well as commercially available ZR resin, the mass of resin used in each generator is given in Table 1. All generators were then subsequently eluted with four bed volumes of 0.5 M HCl daily (or semi-daily for the longer lasting generators) to monitor the amount of ⁴⁴Sc eluted as well as any ⁴⁴Ti breakthrough.

TABLE 1
Masses of Resins Used for 300 μL
BV Generator in a 10 mL Tapered Column

Mass (mg)

| Resin | Blank | Unsubstituted | Methyl | Phenyl |
|---|---|---|---|---|
| Accell | 115 | 125 | 120 | 110 |
| IRC50 | 110 | 170 | 160 | 150 |
| CG50 | 80 | 100 | 105 | 110 |

| | |
|---|---|
| ZR | 80 |

Unsurprisingly all unfunctionalized resins (in the carboxylate form) showed complete ⁴⁴Ti breakthrough during the load and failed to bind appreciable amounts of either metal (Table 2). For the remaining resins, during the 2 M HCl load experiment it was found that all functionalized IRC50 and CG50 resins failed to bind the Ti and displayed complete ⁴⁴Ti breakthrough either during the load or in the subsequent elution (Elute 1). This is likely due to hydrolysis of the hydroxamate groups in the 2 M HCl as described previously. Similar results were found by Holland et al with the unsubstituted Accell based hydroxamate resin, where the loading ⁸⁹Zr(IV) efficiency was found to be >99.9% at HCl concentrations of ≤2 M, but at higher concentrations the binding affinity of the resin decreases drastically. The AU and AM resins, however, displayed 100% ⁴⁴Ti loading efficiency, and the ZR resin showed a small amount of ⁴⁴Ti breakthrough during the load leading to 93.5% ⁴⁴Ti loading efficiency.

TABLE 2
2M HCl Load Generator Experiment ⁴⁴TI Breakthrough

% Ti Breakthrough

| Resin | Load | Elute 1 |
|---|---|---|
| Accell Blank | 100 | — |
| IRC50 Blank | 97 | — |
| CG50 Blank | 100 | — |
| ZR | 6.5 | — |
| Accell UH (AU) | 0 | 0 |
| Accell MH (AM) | 0 | 0 |
| Accell PH (AP) | 72 | 18 |
| IRC50 UH | 96 | 3 |
| IRC50 MH | 100 | — |
| IRC50 PH | 72 | 26 |
| CG50 UH | 93 | 4 |
| CG50 MH | 100 | — |
| CG50 PH | 100 | — |

The ZR, AU and AM generators were eluted daily with 4 bed volumes of 0.5 M HCl. The resulting ⁴⁴Sc activity eluted as well as any potential ⁴⁴Ti breakthrough was monitored through HPGe γ spectroscopy. The AU generator displayed the highest eluted ⁴⁴Sc activity, almost double that of the ZR and AM generators, but also was the first to display ⁴⁴Ti breakthrough. The AU generator was eluted seven times (total 28 BV) over seven days before 0.45% of the load activity ⁴⁴Ti breakthrough was observed on the 8th day, due to the ⁴⁴Ti breakthrough this generator was no longer eluted. The ZR generator was eluted 10 times (total 40 BV) over 10 days before 0.16% of the load activity ⁴⁴Ti breakthrough was observed. The AM generator was eluted 75 times (total 300 BV) over several months before 0.3% of the load activity ⁴⁴Ti breakthrough was observed. The elution profile of these three generators is displayed in FIG. 2. Over the elution period of the AM generator there was a steady increase of ⁴⁴Sc activity eluted from 10% to a maximum of 50%. After this slow increase the elution activity seemed to plateau and remain constant around 40-50%. The reason behind this increasing eluted activity trend is still unknown, although it is hypothesized to be due to protonation of open hydroxamate sites over time by the eluting acid allowing for more ⁴⁴Sc to be eluted and no captured by open sites. If the reason for the increasing ⁴⁴Sc activity was due to the movement of ⁴⁴Ti down the column thereby movement of the ⁴⁴Sc towards the end of the column then we would expect to observe ⁴⁴Ti breakthrough shortly after the maximum ⁴⁴Sc activity was reached, which was not observed. Further studies are needed to ascertain the cause of this observed elution trend.

Interestingly, the activity of eluted ⁴⁴Sc was initially highest for the AU generator (around 20%), while the ZR and AM generators eluted lower activities in the same volume of 0.5 M HCl (both around 10%). However, over time the elution activity for ⁴⁴Sc from the AM generator increased to a maximum of 50% and consistently eluted 45% for the remainder of its lifetime. The reason for this increased activity over time is still unclear, but it may be a result of the protonation of hydroxamate groups in the resin by the dilute HCl over time leading to fewer open coordination sites for the free ⁴⁴Sc to bind.

A scaled-up generator experiment was similarly conducted using the AM resin to test the system in a more clinically relevant scale as it showed extremely promising results in the small scale 7 40 kBq (20 μCi) generator study. A 1 mL BV column (0.400 g AM resin) was loaded with 37 MBq (1 mCi) of ⁴⁴Ti in 2 M HCl. The generator was eluted daily with 4 BV of 2 M HCl and the fractions counted to monitor the ⁴⁴Sc elution activity as well as any potential ⁴⁴Ti breakthrough. The elution profile of this generator is shown in FIG. 12. Remarkably, this generator showed consistent quantitative elution of ⁴⁴Sc on a daily basis using the same volume of eluent (normalized to the column BV) as the small-scale study. The drastic increase in eluted activity may be due to the increased activity: resin ratio, by loading a larger amount of ⁴⁴Ti onto a smaller mass of resin there may be less coordination sites open to bind the free ⁴⁴Sc making it more facile to elute. The lack of ⁴⁴Ti breakthrough observed in the loading procedure suggests that the loading capacity of the resin was not saturated, so it may be possible to load even higher activities onto a 1 mL BV of AM resin. Further studies are needed to determine the saturation point of the resin and what affect this has on subsequent ⁴⁴Sc elution behavior.

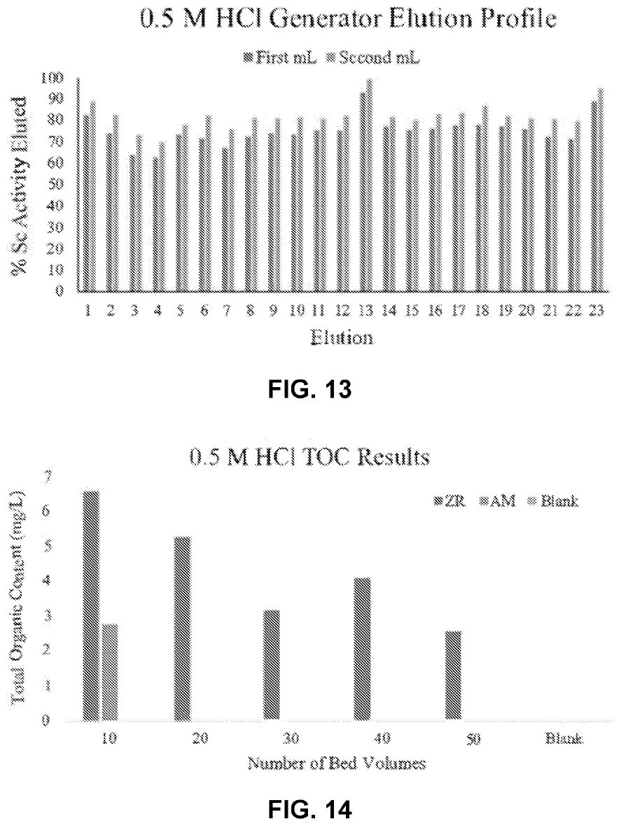

Attempts to further improve this generator towards direct radiolabeling conditions were conducted by eluting in more dilute HCl. A 0.5 mL BV column (0.200 g AM resin) was loaded in 2 M HCl with 37 MBq (1 mCi) of ⁴⁴Ti and then eluted daily with 4 BV of 0.5 M HCl. The elution profile of this generator is shown in FIG. 13. This generator consistently eluted 80-85% ⁴⁴Sc in the 4 BV fractions (2 mL), with 90% of this activity being eluted in the first 1 mL allowing for isolation of 28-30 MBq (750-800 μCi) of ⁴⁴Sc in 1 mL of 0.5 M HCl. Thus, producing a scandium product that should be highly favorable for use in direct radiolabeling experiments.

From the generator studies that have been conducted to date using the AM resin, there has not been any observation of resin degradation or structural damage from radiation from the ⁴⁴Ti or ⁴⁴Sc, even in the higher activity 1 mCi generators. There is a risk that with higher activity generators the hydroxamate-based resin may undergo radiolytic damage from the high energy gammas from ⁴⁴Sc or the positron emission, but further studies are needed.

Study 2: Load in 0.1 M HCl, Elute in 0.5 M HCl. The blank generators were only tested in the 2 M HCl loading experiment as all three showed 100% ⁴⁴Ti breakthrough during the load in the first fraction. The IRC50 resins were also not tested as they had undergone hydrolysis and degraded prior to this study. All generators had 300 μL BV and were loaded on the same day with 20 μCi of ⁴⁴Ti and the same mass of resin was used as in study 1 (Table 1). All generators were then subsequently eluted with four bed volumes of 0.5 M HCl daily (or semi-daily for the longer lasting generators) to monitor the amount of ⁴⁴Sc eluted as well as any ⁴⁴Ti breakthrough.

Similar results were found in the 0.1 M HCl loading experiments, with the ZR, AU and AM resins giving the longest lifetimes without ⁴⁴Ti breakthrough. The IRC50 resins were not tested in the 0.1 M HCl loading experiments as all three of the functionalized resins had degraded in air overtime (few weeks). The slow hydrolysis of the IRC50 resins was evident by the changing IR spectra as well as failed Fe(III) binding tests. The lower molarity HCl loading solution did slow down hydrolysis of the resins evident by the lower ⁴⁴Ti breakthrough (Table 3), but all three CG50 resins as well as the Accell phenylhydroxamate resin (AP) showed consistent breakthrough over the load and two subsequent elutions, so they were abandoned and no longer eluted daily.

TABLE 3
0.1M HCl Load Generator Experiment ⁴⁴Ti Breakthrough

| | % Ti Breakthrough | | |
|---|---|---|---|
| Resin | Load | Elute 1 | Elute 2 |
| ZR | 3 | 2 | 0 |
| Accell UH (AU) | 0 | 0 | 0 |
| Accell MH (AM) | 0 | 0 | 0 |
| Accell PH (AP) | 20 | 10 | 6 |
| CG50 UH | 42 | 7 | 4 |
| CG50 MH | 64 | 19 | 2 |
| CG50 PH | 69 | 15 | 3 |

Similar to study 1, the AU resin was the first to display ⁴⁴Ti breakthrough after 5 elutions (total 20 BV) and the ZR resin after 13 elutions (total 52 BV) (FIG. 3). The AM generator was eluted for a total of 80 times (320 BV) before 0.2% of the load activity ⁴⁴Ti breakthrough was observed. Again, the AU generator initially eluted the highest activity of ⁴⁴Sc at 25%, while the ZR and AM eluted lower amounts at 10% and 5% respectively. Similar to what was seen in the 2 M HCl load test, the amount of ⁴⁴Sc eluted from the AM generator increased over time to about 35% and consistently eluted 30-35% for the remainder of its lifetime. It is worth noting that overall, the elution activities in this experiment have been lower for the AM generator compared to the 2 M HCl experiment, suggesting that loading in the higher molarity acid is preferred. This and the same pattern of increasing activity eluted over time may again be linked to the degree of protonation of the resin hydroxamate groups. Further studies are needed to ascertain the association between acid concentration/pH and resin performance.

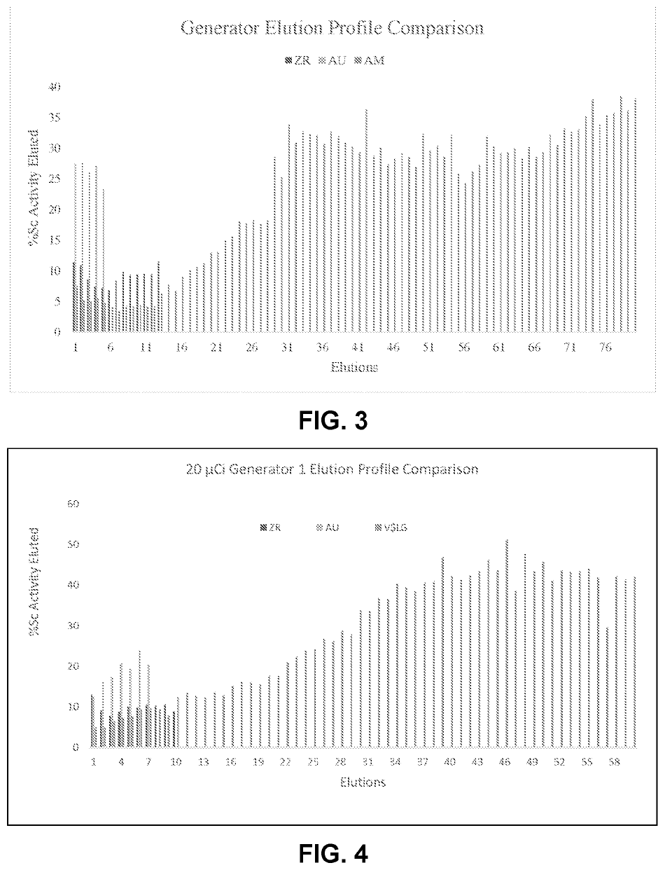

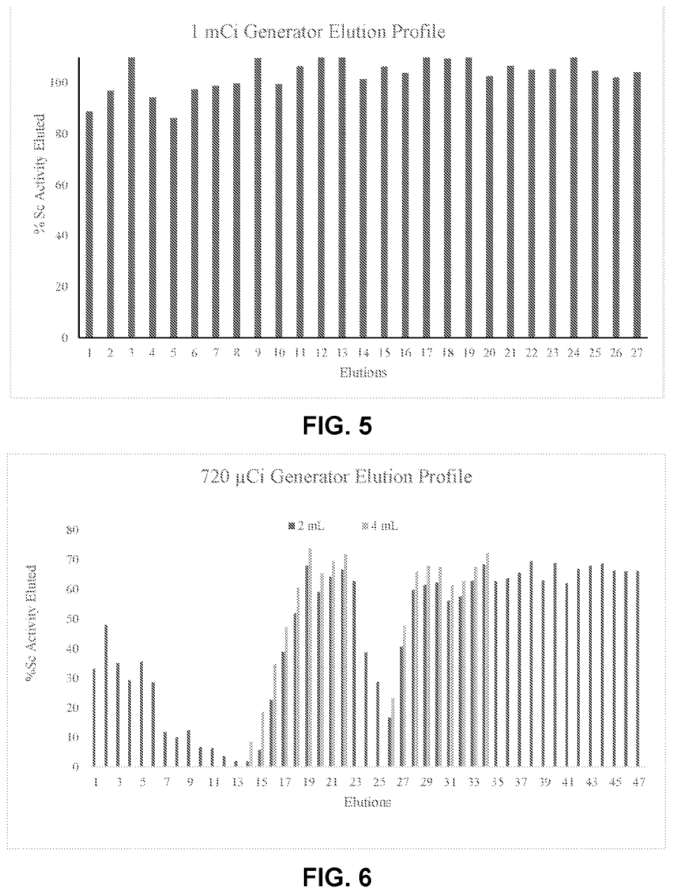

Study 3: Load in 2 M HCl, Elute in 2 M HCl. Due to the strong performance of the AM resin compared to all other synthesized resins, only the AM resin was used in further studies in direct comparison to commercially available ZR resin. The low elution activity of ⁴⁴Sc in the two previous studies prompted the use of higher molarity HCl to elute the generators in attempts to increase the amount of ⁴⁴Sc being eluted in the same volume of eluent. Both the ZR and AM generators had 300 μL BV and were loaded on the same day with 20 μCi of ⁴⁴Ti and used the same mass of resin that was used in the previous studies. Both generators were loaded in 2 M HCl and were subsequently eluted using 4 bed volumes of 2 M HCl daily to monitor the amount of ⁴⁴Sc eluted as well as any ⁴⁴Ti breakthrough. The elution profile of both generators, along with an AU (V$LG) generator, is shown in FIG. 4.

It is immediately evident that the use of higher concentrated acid did indeed increase the amount of ⁴⁴Sc being eluted with values of around 70% for the AM generator compared to 45% (study 1) and 30% (study 2). It is also evident that the lifetime of both the ZR and AM generators was decreased with the use of 2 M HCl, this was more drastic for the AM generator that displayed ⁴⁴Ti breakthrough (0.45%) during the 20th elution (after 76 BV). The lifetime of the AM generator under these conditions was still more than twice that of the ZR generator, but it appears that the use of more concentrated HCl as eluent may be less desired as it possibly expedites the ⁴⁴Ti breakthrough. Further studies are needed varying the concentration of HCl eluent to better ascertain the behavior of the AM resin under varying pHs.

Another AM generator was prepared around the same time both loading and eluting in 2 M HCl on a much bigger scale to assess the viability of this resin in a clinically relevant generator system. A 1 mL BV column (0.400 g AM resin) was loaded with 1 mCi of ⁴⁴Ti, this generator study was conducted in a hotcell due the high activity. This generator was eluted daily with 4 BV of 2 M HCl and the fractions counted to monitor the ⁴⁴Sc elution activity as well as any potential ⁴⁴Ti breakthrough. The elution profile of this generator is shown below in FIG. 5. Remarkably, this generator has shown consistent quantitative elution of ⁴⁴Sc on a daily basis using the same volume of eluent as the other studies. Also interestingly, this generator was eluted 27 times (total 108 BV) without any sign of ⁴⁴Ti breakthrough which differs from the results found in the smaller 300 μL BV 20 μCi generator eluting and loading in the same conditions. It is possible that the breakthrough observed in the study 3 generator was an anomaly, but more experiments are needed to prove this. The drastic increase in eluted activity may be due to the increased activity: resin ratio, by loading a larger amount of ⁴⁴Ti onto a smaller mass of resin there may be less coordination sites open to bind the free ⁴⁴Sc making it more facile to elute. The lack of ⁴⁴Ti breakthrough observed in the loading procedure suggests that the loading capacity of the resin was not saturated, so it may be possible to load even higher activities onto a 1 mL BV of AM resin. Further loading studies are needed to determine the saturation point of the resin and what affect this has on subsequent ⁴⁴Sc elution behavior.

Study 4: Large Scale Load in 2 M, HCl Elute in 0.5 M HCl. The long lifetime of the small-scale (20 μCi, low activity) generators eluted in 0.5 M HCl and the high activity elution of the 1 mCi generator eluted in 2 M HCl led to the study of larger scale (high activity) generators eluting in 0.5 M HCl to see if higher activities of ⁴⁴Sc could be eluted in 0.5 M HCl. A 500 UL BV AM resin (0.200 g) generator was loaded with 720 μCi of ⁴⁴Ti in 2 M HCl and this generator was eluted daily with 0.5 M HCl fractions. Initially this (720 μCi, high activity) generator was eluted with 4×0.5 mL fractions (total of 2 mL), but the eluted activity decreased drastically over the first 13 elutions as can be seen in FIG. 6. In an attempt to increase the eluted activity, the volume of the fractions was increased to 1 mL each, so 4×1 mL fractions (4 mL total) were collected from elutions 14-22. There was an immediate increase in eluted activity seen in these elutions, and initially fractions 3 and 4 contained the majority of this activity, but over time this shifted to fractions 1 and 2 containing the majority of the activity as can be seen in FIG. 6.

Since the eluted activity had increased and 90% of the activity was present in the first two fractions, the fraction volume was decreased back to 0.5 mL for elutions 23-25. The eluted activity immediately decreased as was observed before, so elutions 26-34 were again conducted with 1 mL fractions and the eluted activity again increased. As was observed previously, 90-95% of the eluted activity in these elutions were found in the first 2 fractions (first 2 mL) which suggests that a 2 mL volume should be sufficient to extract the majority of the eluted ⁴⁴Sc, but when the generator is eluted in 4×0.5 mL fractions (2 mL) this activity decreases drastically. This trend suggests that the elution activity dependence may not be volume driven but rather kinetically driven, since 2×1 mL fractions elutes 70% more activity than 4×0.5 mL fractions. Both of these methods use the same volume of 0.5 M HCl to elute, but 1 mL fractions are collected more rapidly than 2×0.5 mL fractions. To test this the generator was eluted using 2×1 mL fractions (2 mL total) for elutions 35-47, and the eluted activity remained around 70% as was seen in elutions 26-34 which used 4 mL total volume. ⁴⁴Ti breakthrough was observed in elution 48 so this generator was abandoned, but this study did prove that a higher activity: resin ratio does increase the amount of activity eluted from the generator (similar to what was observed in the 1 mCi generator) and that kinetics of the elution may impact the eluted activity more than the volume of eluent used. The small-scale generator study that was loaded and eluted in the same solutions only gave 40-45% ⁴⁴Sc eluted in 4 BV of 0.5 M HCl while this generator eluted 70% in 4 BV of 0.5 M HCl.

Another AM resin generator of this type was prepared for ongoing studies, but a smaller 5 cm length×0.5 cm ID column was used to increase the length of the resin bed by using a column with a smaller inner diameter. This should increase the lifetime of the generator by increasing the path length that the ⁴⁴Ti must travel before breakthrough is observed. For a 500 μL BV, the length of the resin bed in the 10 mL tapered BioRad columns is 1 cm while in the smaller 5 cm columns this length increases to 2 cm. This increased length should increase the lifetime of this generator before ⁴⁴Ti breakthrough is observed, ideally by double. This strategy of increasing the length of the resin bed by use of a column with a small inner diameter has been used in the literature, where an HPLC type 150 mm×2.1 mm ID PEEK column is employed. Future studies using this column will be conducted with the disclosed generator system, which should allow for enhanced optimization and longer lifetimes as the resin bed will be 10× longer than previous generators that used the 10 mL BioRad columns which have a 1 cm ID.

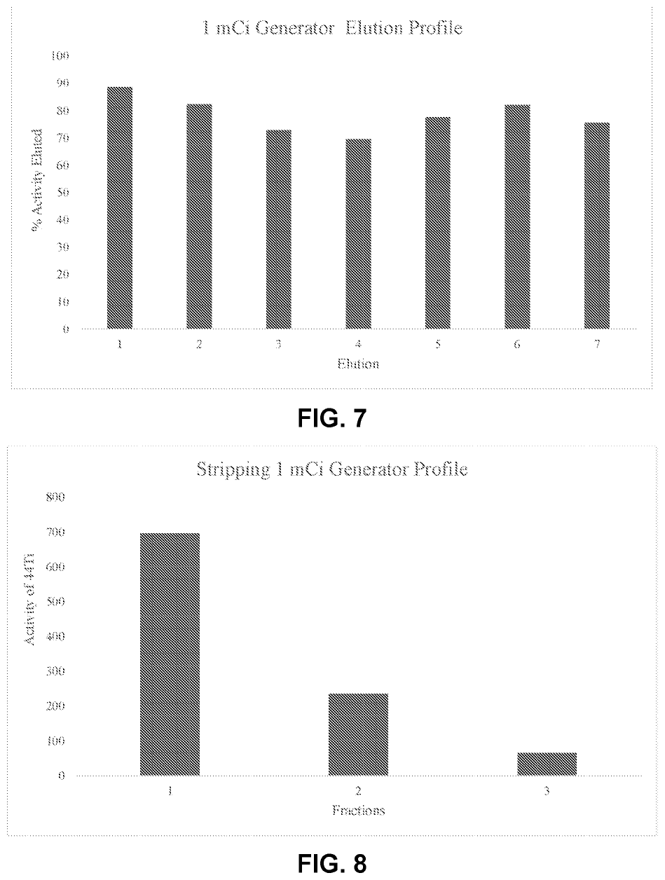

Using the smaller 5 cm column, a 500 UL BV AM resin (0.200 g) generator was prepared loading 1 mCi of ⁴⁴Ti in 2 M HCl. This generator was eluted daily with 2×1 mL fractions of 0.5 M HCl and the elution profile is shown in FIG. 7. In this study the generator has been eluted 7 times, and the eluted ⁴⁴Sc activity has been around 80% with no sign of ⁴⁴Ti breakthrough. This generator may be eluted additional times until breakthrough is observed.

Since both this 1 mCi AM generator and the 720 μCi AM generator are able to elute high activities of ⁴⁴Sc in small volumes of dilute (0.5 M) HCl, the eluent from these generators were used for direct radiolabeling studies. The results of these studies are summarized in the radiolabeling section. Direct radiolabeling was not possible with any of the other generators mentioned in this study since 2 M HCl is too acidic to be used in this sort of labeling reaction, and the smaller scale generators did not elute high enough activities in small volumes to be of use. This is why the dry down method was used prior to radiolabeling studies with ⁴⁴Sc eluted from these generators. It is also worth mentioning that none of the ZR generators prepared in this study eluted sufficient activities of ⁴⁴Sc in appropriate volumes of dilute HCl, so this resin is not conducive to produce ⁴⁴Sc for use in direct radiolabeling reactions.

### Eluent Variability Study

The use of 0.5 M and 2 M HCl as generator eluent with AM resin has already been verified, but the use of other eluents such as buffers was also of interest. If the generator can be eluted successfully using a mild buffer there would be no need for post-elution processing prior to radiolabeling of the ⁴⁴Sc, which would be the most ideal for use in clinical studies. In order to be adequate for direct radiolabeling, the ⁴⁴Sc needs to be eluted in small volumes of slightly acidic (pH 2-7) media without any competitive binding ligands such as oxalates. To test the elution behavior of the AM resin using different eluents, a 300 UL BV 100 μCi ⁴⁴Ti generator was loaded in 2 M HCl and eluted using varying solvents. Between each change of eluent, the column was flushed with water to ensure no residual solvent was left. Each solvent was tested only a few times to ascertain the viability of its use to elute large quantities of ⁴⁴Sc in small volumes without ⁴⁴Ti breakthrough. The generator was eluted with 4 BV of each solvent and the results of the elution are shown in Table 4.

TABLE 4
Elution Behavior of 100 μCi AM Generator with Varying Eluents

| Eluent | % ⁴⁴Sc Eluted | % ⁴⁴Ti Breakthrough |
|---|---|---|
| 0.25M NH₄OAc pH 4 | 2.1 | 0 |
| 0.25M NH₄OAc pH 4 | 0.6 | 0 |
| 0.1M Na Citrate pH 4 | 31.8 | 0.8 |
| 4M HCl | 59.6 | 0 |
| 4M HCl | 36.8 | 0 |
| 4M HCl | 58.0 | 0 |
| 6M HCl | 67.2 | 0 |
| 6M HCl | 77.1 | 0 |
| 6M HCl | 80.7 | 0 |

The use of sodium citrate buffer as an eluent was only attempted once as there was evident ⁴⁴Ti breakthrough observed, and the use of NH₄OAc buffer was only conducted twice as the activity of ⁴⁴Sc was negligible. From these results it is evident that the use of a radiolabeling buffer as an eluent is not viable, as the NH₄OAc is not able to efficiently remove the ⁴⁴Sc, and while the sodium citrate was successful in eluting modest activities of ⁴⁴Sc, the citrate also appears to be a competitive binder for the ⁴⁴Ti and leads to breakthrough. Similar to what was seen in the smaller generator studies, by increasing the molarity of HCl eluent the amount of ⁴⁴Sc eluted is also increased. This is demonstrated by the gradual increase of eluted activity from 0.5, 2, 4 and 6 M HCl. This strongly suggests that pH is a strong contributing factor in the elution of ⁴⁴Sc from the AM resin. While the percentage of ⁴⁴Sc eluted in small volumes of 4 and 6 M HCl is high, it is far too acidic to be used in subsequent radiolabeling experiments without diluting or neutralizing (which is difficult at these high molarities), so it is a less ideal option.

### Distribution Coefficient (K_{D}) Studies

K_{D} values were obtained using the batch contact method. 20 mg of AM resin was prepared in 1.5 mL Eppendorf vials. Stock solutions for each metal were prepared by diluting High Purity ICP standards (100 ppm for Sc and 1000 ppm for Ti, both in 2% HNO₃) in HCl at various concentrations (0.5, 1, 2, 4, 8 and 10.8 M) to a final concentration of 10 ppm. Initial studies were conducted by first drying down the ICP standards and re-dissolving in the appropriate HCl concentration, but the results did not vary statistically from those obtained by the direct dilution method, so it was determined that the small amount of HNO₃ present in the initial metal solutions did not affect or contribute to the resulting distribution coefficients. 1 mL of these standard solutions was then added to the vials containing the resin which were then sealed and mixed by inversion at room temperature for 24 h to allow for equilibration. Following mixing, the tubes were centrifuged and a 500 μl aliquot obtained, diluted in 2% HNO₃ and submitted for ICP-OES analysis to determine the concentration of analyte remaining in the aqueous phase. This was compared to the concentration of the initial cold metal standard and the distribution coefficient calculated using the following equation, where C8 and CA are the elemental concentrations of the analyte in solution before and after equilibrium respectively (Equation (1)). Each experiment was done in triplicate at each concentration range.

$${K}_{D} = \frac{( {C}_{B} - {C}_{A} ) / w}{{C}_{A} / v} \qquad Equation ( 1 )$$

### Total Organic Content

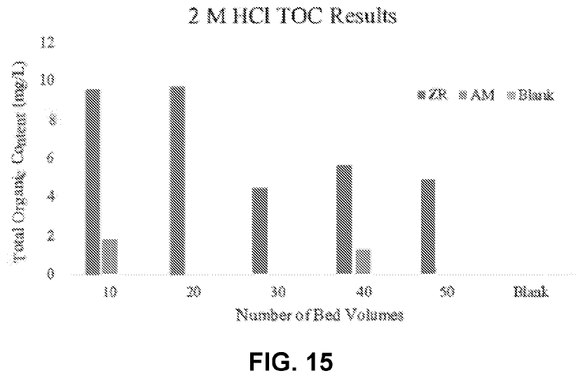

To determine and compare the amount of organic impurities that are potentially being eluted from the extraction chromatographic ZR resin and the covalently bound synthesized AM resin, small columns containing the resin were prepared and eluted with 0.5 M and 2 M HCl. The eluent was collected and sent for total organic content analysis. The results of the analysis arc shown below, the 0.5 M HCl in FIG. 14 and the 2 M HCl in FIG. 15. In both cases the acid used did not show any organic content in the blank samples and therefore did not contribute to any organic content found in the column eluent samples. For both acid concentrations there is considerably more organic impurities being eluted from the ZR resin column, where there is little to no organic impurities being eluted from the AM resin columns. These results suggest that ⁴⁴Sc eluted from an AM resin generator has the potential to be directly radiolabeled without any post-elution processing or purification as there are no organic impurities being eluted from the resin itself that would inhibit ⁴⁴Sc radiolabeling.

### Specific Activity of Generator Produced ⁴⁴Sc

To determine the specific activity of the AM resin generator produced ⁴⁴Sc, the eluted fractions from the 1 mCi 2 M HCl eluted generator were collected and analyzed by ICP-OES (Supplementary Materials) to determine the amount of cold Sc in the collected eluent. All four fractions from each elution 1, 5, 10, 15, 20, and 25 were combined, diluted to 8 mL in 2% HNO₃ and each analyzed by ICP-OES. The analyzed Sc peaks from elution 20 had an RSD of 43% so no reliable data was obtained, but all remaining elution samples had RSD values below 10% and the resulting Sc concentration and amount are given in Table 5.

TABLE 5
Resulting Scandium ICP-OES Data from 1 mCi 2M HCl Generator Elutions

| | | | Combined | Amount of Sc | |
|---|---|---|---|---|---|
| | Combined | ICP Sample Sc | Fractions Sc | in Combined | |
| | Fractions | Concentration | Concentration | Fractions | |
| Elution | Volume (mL) | (ppm) | (ppm) | (mg) | % RSD |
| 1 | 3.885 | 0.001 | 0.0021 | 0.008 | 1.03 |
| 5 | 3.195 | 0.001 | 0.0025 | 0.008 | 1.09 |
| 10 | 3.374 | 0 | 0^{a} | 0^{a} | 9.14 |
| 15 | 4.148 | 0 | 0^{a} | 0^{a} | 8.11 |
| 20 | 3.129 | 0 | — | — | 43.41 |
| 25 | 3.633 | 0.001 | 0.0022 | 0.008 | 2.45 |

^{a}Below detection limit.

These results demonstrate that there is very little cold scandium in the eluted fractions from the AM resin generator, suggesting that the eluted ⁴⁴Sc is carrier free, or at the very least that the amount of cold scandium in the elutions is below the detection limit of the ICP-OES.

Stripping of ⁴⁴Ti from AM Resin

Stripping of the ⁴⁴Ti from the AM resin was tested using several different solvents. Ideally the stripping solution should be able to isolate the full amount of ⁴⁴Ti in relatively small volumes in a form that is not chemically detrimental to the ⁴⁴Ti. Initially, concentrated HCl and HNO₃ were tested; four bed volumes of each concentrated acid were passed through study 3 generator (300 μL BV, 20 μCi) in attempts to remove the ⁴⁴Ti (Table 6). Remarkably neither acid eluted appreciable amount of ⁴⁴Ti. This suggests that once the Ti is bound, the AM resin tightly retains Ti- and is robust and fairly resistant to harsh low pH conditions.

TABLE 6
Stripping Attempts Using 4 BV of Concentrated Acids

| Acid | % ⁴⁴Sc Eluted | % ⁴⁴Ti Eluted |
|---|---|---|
| HCl | 95.5 | 0.5 |
| HNO₃ | 88.0 | 2.6 |

The use of dilute H₂O₂ in HCl has been used to efficiently strip ⁴⁴Ti from the ZR resin so that was also tested. 2% H₂O₂ in 2 M HCl was used to strip the 1 mCi generator, and 99.8% ⁴⁴Ti was recovered in 24 BV, although 70% was recovered in the first 8 BV (FIG. 8). These stripping conditions use mild solvents that do not interfere with the chemical form of the ⁴⁴Ti and do not contain any chelating agents that would need to be removed in post-processing experiments. The volume used may be optimized by use of varying amounts of % H₂O₂ and varying concentration of HCl, but further studies are needed for this optimization.

### Radiolabeling Experiments

To assess the purity of the eluted ⁴⁴Sc, radiolabeling experiments were conducted on ⁴⁴Sc eluted from both the 1 mCi AM generator eluted in 2 M HCl, as well as a 100 μCi 300 μL BV ZR generator as direct comparison. All of these radiolabeling studies using ⁴⁴Sc eluted from these generators were conducted using the dry down method mentioned previously. Both of these generators were eluted using 4 BV of 2 M HCl, and a portion of the eluent was evaporated to dryness at 140° C. on a hotplate, and then re-dissolved in 0.25 M NH₄OAc pH 4 buffer in order to be radiolabeled. Both eluents were processed and radiolabeled in the exact same manner to ensure a direct comparison between the two different generator-produced ⁴⁴Sc samples. The radiolabeling experiments were done using three different chelators (DOTA, NOTA and HOPO), but in each case the experiment conditions were the same. The appropriate amount of ligand was added to the ⁴⁴Sc solution and heated at 90° C. for one hour in a thermomixer. The radiolabeling yield was then determined using radio TLC conditions as described above. The DOTA and HOPO reactions were done using a 50,000 ligand molar excess, and the NOTA using a 100,000 ligand molar excess due to the lower thermodynamic stability of Sc-NOTA complexes. Each radiolabeling experiment was conducted in triplicate using different generator eluents (done on different days) and the TLCs were also each done in triplicate to ensure consistent results. The results of these radiolabeling experiments are summarized in Table 7.

TABLE 7
Radiolabeling Yields Determined by RadioTLC

| | AM | ZR |
|---|---|---|
| DOTA | 98.75% ± 0.68 | 38.19% ± 7.74 |
| NOTA | 97.42% ± 0.59 | 10.71% ± 12.19 |
| HOPO | 86.86% ± 7.43 | 38.77% ± 12.61 |

The error associated with the ZR generator experiments is slightly higher due to the lower activity used, and the separation of peaks in the HOPO and NOTA experiments were not as clean as with DOTA leading to slightly higher errors in those experiments. Overall, it is clear that the AM generator produced ⁴⁴Sc labeled much better than the ZR ⁴⁴Sc under the same conditions, suggesting that it is of higher purity. It is worth noting that the ZR ⁴⁴Sc solution after processing is yellow in color, where the AM solution is completely colorless. This color is likely due to an organic-based impurity, possibly from the ZR resin, as the ⁴⁴Sc or radiolabeled complexes should be completely colorless. The characterization of this impurity is currently unknown but seems to hinder the radiolabeling of the ZR generator eluted radioisotope.

The ⁴⁴Sc eluent from the 720 μCi and 1 mCi generators that were loaded in 2 M HCl and eluted in 0.5 M HCl were used in direct radiolabeling experiments since the eluent was in a form conducive to this method of labeling. The ⁴⁴Sc generator eluent in 0.5 M HCl was initially neutralized with equal amounts of 0.5 M NaOH and then added to the appropriate amount of ligand stock solution in 0.25 M NH₄OAc pH 4 buffer. This solution had an overall pH of 4. This solution was then heated at 90° C. for 1 hour in a thermomixer and the radiolabeling yield was then determined using radio TLC conditions as described previously. An initial experiment was conducted with 50,000 molar equivalents of DOTA (similar to what was conducted in the dry down method) and the radioyield was 99.46%+0.05%. This excess was then decreased to 25,000 molar equivalents of DOTA and the resulting radioyield remained high at 99.28%+0.08%. This was then decreased further to 10,000 molar equivalents of DOTA, and the average radioyield from four separate reactions was 85.10%+10.57%. A comparison labeling study was done with 10,000 molar equivalents of DOTA using the dry down method which gave a radioyield of 9.36%+0.16%. The direct radiolabeling method not only allows for more quick and facile labeling studies as post-elution processing is not needed, but it also showed drastically higher yields at lower ligand amounts compared to the dry down method. Further studies are needed to optimize these labeling studies, but the use of AM resin generator produced ⁴⁴Sc obtained in 0.5 M HCl shows extremely promising direct radiolabeling results which is currently not possible with ⁴⁴Ti/⁴⁴Sc generators in the literature.

One of the biggest drawbacks to currently employed ⁴⁴Sc generators is that the eluent needs post-elution purification in order to use the ⁴⁴Sc in subsequent radiolabeling reactions. This is due to the presence of competing chelators in the eluent such as the oxalates present in oxalic acid. To overcome this, current methods employ the use of a second column to purify the ⁴⁴Sc by removal of the oxalates and isolation of the ⁴⁴Sc in a radiolabeling conducive buffer. To avoid post-elution processing of the generator eluent and allow for direct radio labeling of the ⁴⁴Sc several criteria need to be met: the eluent must be free of competing chelators, the eluent must not be highly acidic, and the volume: activity ratio must be low in order to keep radiolabeling reaction total volumes reasonable. The generator presented in this work meets all of these criteria and should allow for use of the eluted ⁴⁴Sc directly from the generator without the need of time-consuming post-elution processing and loss of activity.

To test this, preliminary radiolabeling studies were conducted on the generator eluent from the 37 MBq (1 mCi) generator eluted with 0.5 M HCl with DOTA under standard radiolabeling conditions. The ⁴⁴Sc was obtained in 0.5 M HCl and then brought to a pH of 4 with the addition of 0.5 M NaOH. This solution was then added directly to an Eppendorf vial containing DOTA stock solution in 0.25 M NH₄OAc at a pH of 4, with a resulting pH of 4 for the reaction solution. The solution was heated at 90° C. for 60 min and the radioyield determined by iTLC. This reaction was conducted using 925 kBq (25 μCi) of ⁴⁴Sc and 1.59 nmol of DOTA resulting in a 99.24±0.21% yield, which is consistent with other generator produced ⁴⁴Sc samples that have been processed using chromatography post-elution. More studies are needed to further optimize and study the radiolabeling efficiencies of this generator produced ⁴⁴Sc, but these preliminary results show extremely promising evidence for the ability to directly radiolabel ⁴⁴Sc from this generator system.

### Example 3: Alternative Radionuclide Systems

In another embodiment, the present generator may be a ¹⁷²Hf/¹⁷²Lu generator system comprising the use of an alkyl-substituted hydroxamate resin and a method of producing ¹⁷²Lu comprising decay of ¹⁷²Hf in a ¹⁷²Hf/¹⁷²Lu generator system using an alkyl-substituted hydroxamate resin.

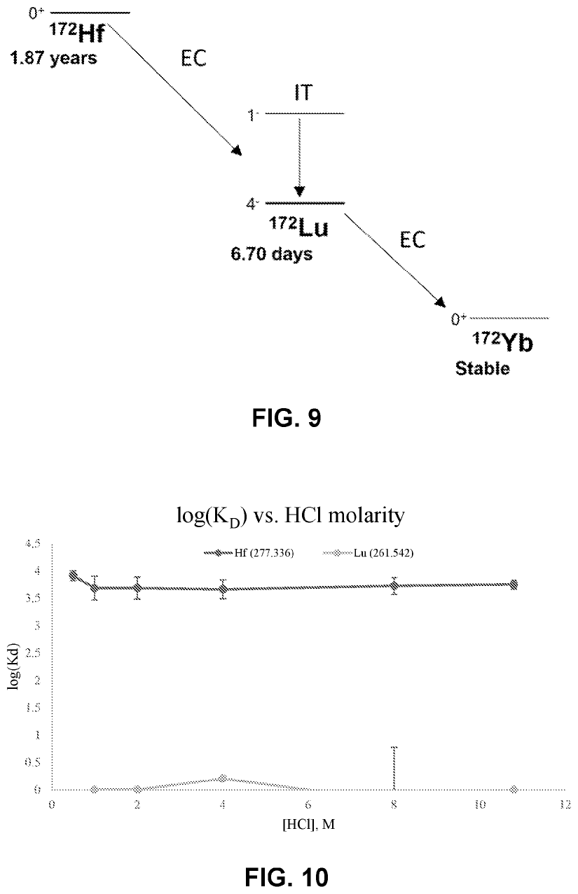

¹⁷²Hf has a half life of 1.87 years and decays by electron capture (EC) to ¹⁷²Lu (t_{1/2}=6.7 days) which then decays by electron capture to stable ¹⁷²Yb (FIG. 9). This decay scheme matches what is needed for a radionuclide generator system, mainly the succinct decay of a long-lived parent radioisotope (¹⁷²Hf) to a short-lived daughter radioisotope (¹⁷²Lu) which can be used in nuclear medicine. ¹⁷²Lu is of interest as an imaging agent in preclinical studies.

In the case that Hf is most stable in the (IV) oxidation state and Lu is only stable in the (III) oxidation state, this is similar to Ti(IV) and Sc(III). Although the ionic radii of Hf and Lu are larger than that of Ti and Sc, they possess similarities in bonding, so the hydroxamate groups of the resin will likely selectively bind Hf over Lu and allow for retention of ¹⁷²Hf on the resin matrix and elution of ¹⁷²Lu.

Preliminary cold studies were conducted using the methyl hydroxamate resin to ascertain the distribution coefficient (K_{D}) for both Hf and Lu in varying concentrations of HCl to determine the extent of this generator system (FIG. 9). As shown in the plot, Hf is retained strongly on the resin across all concentration of the acid, similarly to Ti. Lu, on the other hand, show little to no retention across the HCl concentrations. Based on the similarities in the K_{D} results of the Ti/Sc and Hf/Lu studies we believe that this resin would also serve as a suitable generator for Hf/Lu.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### REFERENCES

1. Agrawal, Y. K., et al, 1999. Poly (styrene-p-hydroxamic acids): synthesis, and ion exchange separation of rare earths. React. Funct. Polym. 39. 155-164.
2. Antimicrobial Resistance C. Global burden of bacterial antimicrobial resistance in 2019: a systematic analysis. Lancet 2022; 399 (10325): 629-655.
3. Bae T et al. Generating a collection of insertion mutations in the Staphylococcus aureus genome using bursa aurealis. Methods Mol Biol 2008; 416:103-116.
4. Bafaro E et al. The emerging role of zinc transporters in cellular homeostasis and cancer. Signal Transduct Target Ther 2017; 2.
5. Bilinskaya A et al. Variability in Zinc Concentration among Mueller-Hinton Broth Brands: Impact on Antimicrobial Susceptibility Testing of Metallo-beta-Lactamase-Producing Enterobacteriaceae. J Clin Microbiol 2020; 58 (12).
6. Bohlmann L et al. Chemical Synergy between Ionophore PBT2 and Zinc Reverses Antibiotic Resistance. mBio 2018; 9 (6).
7. Brandenburg K S et al. Novel murine model for delayed wound healing using a biological wound dressing with Pseudomonas aeruginosa biofilms. Microb Pathog 2018; 122:30-38.
8. Brazel E B et al. Dysregulation of Streptococcus pneumoniae zinc homeostasis breaks ampicillin resistance in a pneumonia infection model. Cell Rep 2022; 38 (2): 110202.
9. Brennan, B. J., et al, 2016. Molecular titanium-hydroxamate complexes as models for TiO₂ surface binding. Chem. Commun. 52, 2972-2975.
10. Brown E D et al. Antibacterial drug discovery in the resistance era. Nature 2016; 529 (7586): 336-343.
11. Cornaz, J. P., et al, 1954. Selektive lonenaustauscher fur Fe3+ 1. Experientia 10, 137-138.
12. Cornaz. J.-P., et al. 1957. S3urechloride und Hydroxamsauren von Carboxyl-lonenaustauschem. 10. Mitteilung Uber lonenaustauscher. Helv. Chim. Acta 40, 2015-2019.
13. Crawford C L et al. A copper-dependent compound restores ampicillin sensitivity in multidrug-resistant Staphylococcus aureus. Sci Rep 2020; 10 (1): 8955.
14. Crawford C L et al. Pyrazolopyrimidinones, a novel class of copper-dependent bactericidal antibiotics against multi-drug resistant S. aureus. Metallomics 2019; 11 (4): 784-798.
15. Dalecki A G et al. Combinatorial phenotypic screen uncovers unrecognized family of extended thiourea inhibitors with copper-dependent anti-staphylococcal activity. Metallomics 2016; 8 (4): 412-421.
16. Dalecki A G et al. Targeting Biofilm Associated Staphylococcus aureus Using Resazurin Based Drug-susceptibility Assay. J Vis Exp 2016; (111).
17. Davidson, D., 1940. Hydroxamic acids in qualitative organic analysis. J. Chem. Educ. 17, 81.
18. De Oliveira D M P et al. Rescuing Tetracycline Class Antibiotics for the Treatment of Multidrug-Resistant Acinetobacter baumannii Pulmonary Infection. mBio 2022: e0351721.
19. Dirks, C. B. A., et al, 2015. On the Development and Characterisa tion of an Hydroxamate Based Extraction Chromatographic Resin. 6 1st Radiobioassay and Radiochemistry Measurements Conference. Iowa City, IA, USA.
20. Domnanich, K. A., et al, 201 7. (44)Sc for labeling of DOTA- and NODAGA-functionalized peptides: preclinical in vitro and in vivo investigations. EJNMMI Radiopharm Chem 1, 8.
21. Eigner, S., et al, 2013. Imaging of protein synthesis: in vitro and in vivo evaluation of 44Sc-DOTA-Puromycin. Mal. Imag. Biol. 15, 79-86.
22. Eskenazi A et al. Combination of pre-adapted bacteriophage therapy and antibiotics for treatment of fracture-related infection due to pandrug-resistant Klebsiella pneumoniae. Nat Commun 2022; 13 (1): 302.
23. Fey P D et al. A genetic resource for rapid and comprehensive phenotype screening of nonessential Staphylococcus aureus genes. mBio 2013; 4 (1): e00537-00512.
24. Filosofov, D. V., et al, 2010. A 44TV44Sc radionuclide generator for potential application of 44Sc-based PET-radiopharmaceuticals. rca-Radiochimica Acta 98, 149-156.
25. Gao W et al. Nanomaterials arising amid antibiotic resistance. Nat Rev Microbiol 2021; 19 (1): 5-6.
26. Hemansez, R., et al, 2014. 44Sc: an attractive isotope for peptide-based PET imaging. Mal. Pharm. 11, 2954-2961.
27. Herscheid, J. D., et al, 1983. Manganese-52m for direct application: a new 52Fe/52mMn generator based on a hydroxamate resin. Int. J. Appl. Radiat. Isot. 34, 883-886.
28. Higgins, F. S., et al, 2006. Infrared and Raman spectroscopy study of alkyl hydroxamic acid and alkyl hydroxamate isomers. Appl. Spectrosc. 60, 279-287.
29. Holland, J. P., et al, 2009. Standardized methods for the production of high specific-activity zirconium-89. Nucl. Med. Biol. 36, 729-739.
30. Honarvar, H., et al, 2017. Evaluation of the first 44Sc-labeled Affibody molecule for imaging of HER2-expressing tumors. Nucl. Med. Biol. 45, 15-21.
31. Hood M I et al. Nutritional immunity: transition metals at the pathogen-host interface. Nat Rev Microbiol 2012; 10 (8): 525-537.
32. Johnson B A et al. Bacitracin: A New Antibiotic Produced by a Member of the B. Subtilis Group. Science 1945; 102 (2650): 376-377.
33. Jones, K. E., et al, 2017. Ti(IV) and the siderophore desferrioxamine B: a tight complex has biological and environmental implications. Inorg. Chem. 56, 1264-1272.
34. Kehl-Fie T E et al. Nutritional immunity beyond iron: a role for manganese and zinc. Curr Opin Chem Biol 2010; 14 (2): 218-224.
35. Kennedy A D et al. Epidemic community-associated methicillin-resistant Staphylococcus aureus: recent clonal expansion and diversification. Proc Natl Acad Sci USA 2008; 105 (4): 1327-1332.
36. Kennedy A D, et al. Complete nucleotide sequence analysis of plasmids in strains of Staphylococcus aureus clone USA300 reveals a high level of identity among isolates with closely related core genome sequences. J Clin Microbiol 2010; 48 (12): 4504-4511.
37. Kerdjoudj, R., et al, 2016. Scandium (iii) complexes of monophosphorus acid DOTA analogues: a thermodynamic and radiolabelling study with 44Sc from cyclotron and from a 44Ti/44Sc generator. Dalton Trans. 45, 1398-1409.
38. Khodadadi, R., et al, 1995. Poly (hydroxamic Acid) Chelating Resin: the Synthesis and Uses. Iran. J. Polymer. Sci. Tech. 4, 248-255.
39. Koumarianou, E., et al, 201 2. 44Sc-DOTA-BN[2-14]NH2 in comparison to 6 8Ga-DOTA-BN[2-14]NH2 in pre-clinical investigation. Is 44Sc a potential radionuclide for PET? Appl. Radiat.! sot. 70, 2669-2676.
40. Larenkov, A. A., et al, 2021. Separation of 44Sc from 44Ti in the context of A generator system for radiopharmaceutical purposes with the example of [44Sc]Sc-PSMA-6 17 and [44Sc]Sc-PSMA-I& T synthesis. Molecules 26, 6371.
41. Lelievre P et al. The Multifaceted Roles of Copper in Cancer: A Trace Metal Element with Dysregulated Metabolism, but Also a Target or a Bullet for Therapy. Cancers (Basel) 2020; 12 (12).
42. Lewis K. Antibiotics: Recover the lost art of drug discovery. Nature 2012; 485 (7399): 439-440.
43. Ling L L et al. A new antibiotic kills pathogens without detectable resistance. Nature 2015; 517 (7535): 455-459.
44. Liu, C. Y., et al, 1992. Synthesis and coordination behavior of hydroxamate resin with varying spacer groups. Polyhedron 11, 551-558.
45. Mawji, E., 2008. Hydroxamate siderophores: occurrence and importance in the Atlantic ocean. Environ. Sci. Technol. 42, 8675-8680.
46. Meijs, W. E., et al, 1994. Production of highly pure no-carrier added 89Zr for the labelling of antibodies with a positron emitter. Appl. Radiat. Isot. 45, 1143-1147.
47. Ming L J et al. Metal binding and structure-activity relationship of the metalloantibiotic peptide bacitracin. J Inorg Biochem 2002; 91 (1): 46-58.
48. Muller, C. et al. 2013. Promises of cyclotron-produced 44Sc as a diagnostic match for trivalent β-emitters: in vitro and in vivo study of a 44Sc-DOTA-Folate conjugate. J. Nucl. Med. 54, 2168-2174.
49. Orlowska, E., et al, 2016. Benzoic hydroxamate-based iron complexes as model compounds for humic substances: synthesis, characterization and algal growth experiments. RSC Adv. 6, 40238-40249.
50. Padial, N. M., et al, 2019. Hydroxamate titanium-organic frameworks and the effect of siderophore-type linkers over their photocatalytic activity. J. Am. Chem. Soc. 141, 13124-13133.
51. Passadis, S. S., Hadjithoma, S., Siafarika, P., Kalampounias, A. G., Keramidas, A. O., Miras, H. N., Kabanos, T. A., 2021. Synthesis, structural and physicochemical characterization of a titanium (IV) compo und with the hydroxamate ligand N,2-Dihydroxybenzamide. Molecules 26, 5588.
52. Petrie, G., Locke, D., Meloan, C. E., 1965. Hydroxamic acid chelate ion exchange resin. Anal. Chem. 37, 919-&.
53. Phillips, R. J., Fritz, J. S., 1980. Synthesis and analytical properties of an n-phenylhydroxamic acid resin. Anal. Chim. Acta 121, 225-232.
54. Phillips, R. J., 1980. Chelating ion exchange with macroreticular hydroxamic acid resins. Doctor of Philosophy, Iowa State University.
55. Phillips, R. J., Fritz, J. S., 1982. Extraction of metal ions by N-phenyl-, N-methyl-, and Nunsubstituted hydroxamic acid resins. Anal. Chim. Acta 139, 237-246.
56. Pruszyn ki, M., Loktionova, N. S., Filosofov, D. V., Reisch, F., 2010. Post-elution processing of 44Ti/44Sc generator-derived 44Sc for clinical application. Appl. Radiat.! sot. 68, 1636-1641.
57. Radchenko, V., Meyer, C. A. L., Engle, J. W., Naranjo, C. M., Unc, G. A., Mastren, T., Brugh, M., Birnbaum, E. R., John, K. D., Nortier, F. M., Fassbender, M. E., 2016. Separation of 44Ti from proton irradiated scandium by using solid-phase extraction chromatography and design of 44Ti/44Sc generator system. J. Chromatogr. A 1477, 39-46.
58. Radford R J et al. Chelators for investigating zinc metalloneurochemistry. Curr Opin Chem Biol 2013; 17 (2): 129-136.
59. Ramchandani D et al. Copper depletion modulates mitochondrial oxidative phosphorylation to impair triple negative breast cancer metastasis. Nat Commun 2021; 12 (1): 7311.
60. Reddy, A. S., Kumar, M. S., Reddy, G. R., 2000. A convenient method for the preparation of hydroxamic acids. Tetrahedron Lett. 41, 6285-6288.
61. Renfrow, W. B., Hauser, C. R., 1937. The relative rates of decomposition of the potassium salts of certain meta and para substituted dibenzhydroxamic acids. A study of the lossen Rearrangement, J. Am. Chem. Soc.!: >9, :I3U8-:I314.
62. Roesch, F., 2012. Scandium-44: benefits of a long-lived PET radionuclide available from the (44)Ti/(44)Sc generator system. Curr. Rad. 5, 187-201.
63. Saxena, M., Loza-Rosas, S. A., Gaur, K., Sharma, S., Perez Otero, S. C., Tinoco, A. D., 2018. Exploring titanium ([V) chemical proximity to iron (HI) to elucidate a function for Ti(IV) in the human body. Coord. Chem. Rev. 363, 109-125.
64. Shukla R et al. Mode of action of teixobactins in cellular membranes. Nat Commun 2020; 11 (1): 2848.
65. Silver L L. Challenges of antibacterial discovery. Clin Microbiol Rev 2011; 24 (1): 71-109.
66. Speer A et al. Copper-boosting compounds: a novel concept for antimycobacterial drug discovery. Antimicrob Agents Chemother 2013; 57 (2): 1089-1091.
67. Szaniszlo, P. J., Powell, P. E., Reid, C. P. P., Cline, G. R., 1981. Production of hydroxamate siderophore iron chelators by ectomycorrhizal Fungi. Mycologia 73, 1 158-1174.
68. Wang F et al. Turning tumor-promoting copper into an anti-cancer weapon via high-throughput chemistry. Curr Med Chem 2010; 17 (25): 2685-2698.
69. Wong, P. T., Bhattacharjee, S., Cannon, J., Tang, S., Yang, K., Bowden, S., Vamau, V., O'Konek, J. J., Choi, S. K., 2019. Reactivity and mechanism of a-nucleophile scaffolds as catalytic organophosphate scavengers. Org. Biomol. Chem. 17, 3951-3963.

1. An alkyl-substituted hydroxamate resin of Formula I: 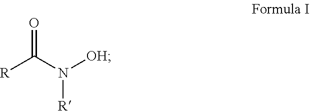
wherein R comprises a resin backbone that is a polymer-coated silica based media and wherein R′ comprises an alkyl group, and wherein the alkyl group is branched or unbranched, is saturated, and has from about 1 to about 12 carbon atoms in its longest chain.

2. The alkyl-substituted hydroxamate resin of claim 1, wherein R′ is methyl.

3. The alkyl-substituted hydroxamate resin of claim 1, wherein the resin preferentially binds a parent isotope over a daughter isotope.

4. The alkyl-substituted hydroxamate resin of claim 3, wherein the resin has a distribution coefficient of greater than or equal to 5000 for the parent isotope and a distribution coefficient of less than or equal to 5 for the daughter isotope.

5. The alkyl-substituted hydroxamate resin of claim 3, wherein the parent isotope comprises ⁴⁴Ti and the daughter isotope comprises ⁴⁴Sc.

6. The alkyl-substituted hydroxamate resin of claim 3, wherein the parent isotope comprises ¹⁷²Hf and the daughter isotope comprises ¹⁷²Lu.

7. A radionuclide generator system comprising an elution bed, wherein the elution bed comprises an alkyl-substituted hydroxamate resin of Formula I: 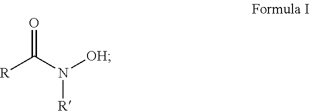
wherein R comprises a resin backbone that is a polymer-coated silica based media and wherein R′ comprises an alkyl group, and wherein the alkyl group is branched or unbranched, is saturated, and has from about 1 to about 12 carbon atoms in its longest chain.

8. The radionuclide generator system of claim 7, wherein R′ is methyl.

9. The radionuclide generator system of claim 7, wherein the radionuclide generator system preferentially retains a parent isotope in contact with the alkyl-substituted hydroxamate resin while allowing a daughter isotope to be eluted.

10. The radionuclide generator system of claim 9, wherein the resin has a distribution coefficient of greater than or equal to 5000 for the parent isotope and a distribution coefficient of less than or equal to 5 for the daughter isotope.

11. The radionuclide generator system of claim 9, wherein the parent isotope comprises ⁴⁴Ti and the daughter isotope comprises ⁴⁴Sc.

12. The radionuclide generator system of claim 9, wherein the parent isotope comprises ¹⁷²Hf and the daughter isotope comprises ¹⁷²Lu.

13. The radionuclide generator system of claim 7, wherein the elution bed has a bed volume of from about 0.3 mL to about 2 mL.

14. The radionuclide generator system of claim 9, wherein the system is loaded with from about 20 μCi to about 10 mCi of the parent isotope.

15. A method for producing ⁴⁴Sc, the method comprising:
(a) contacting ⁴⁴Ti with an alkyl-substituted hydroxamate resin of Formula I: 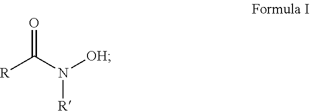
wherein R comprises a resin backbone that is a polymer-coated silica based media and wherein R′ comprises an alkyl group, and wherein the alkyl group is branched or unbranched, is saturated, and has from about 1 to about 12 carbon atoms in its longest chain;
(b) allowing at least a portion of the ⁴⁴Ti to decay to ⁴⁴Sc; and
(c) eluting the ⁴⁴Sc.

16. The method of producing ⁴⁴Sc according to claim 15, wherein R′ is methyl.

17. The method of claim 15, wherein the ⁴⁴Sc is eluted with a dilute aqueous solution.

18. The method of claim 15, wherein the dilute aqueous solution comprises HCl, saline, or any combination thereof.

19. (canceled)

20. The method of claim 18, wherein the ⁴⁴Sc is eluted with at least one bed volume of the HCl acid.

21. The method of claim 15, wherein step (c) can be repeated one or more times before the resin releases any ⁴⁴Ti.
